(19) United States
(12) Patent Application Publication
(10) Pub. No.: US 2017/0100918 A1
(43) Pub. Date: Apr. 13, 2017

(54) HIGH RIGIDITY INTERLAYERS AND LIGHT WEIGHT LAMINATED MULTIPLE LAYER PANELS

(71) Applicant: SOLUTIA INC., ST. LOUIS, MO (US)

(72) Inventor: JUN LU, EAST LONGMEADOW, MA (US)

(73) Assignee: SOLUTIA INC., ST. LOUIS, MO (US)

(21) Appl. No.: 14/879,720

(22) Filed: Oct. 9, 2015

(51) Int. Cl. B32B 17/10; B32B 27/22; B32B 3/26; B32B 27/42

(52) U.S. Cl. CPC B32B 17/10761; B32B 27/42; B32B 27/22; B32B 17/10605; B32B 17/10568; B32B 17/10036; B32B 3/26; B32B 2307/102; B32B 2605/00

(57) ABSTRACT

This disclosure is related to the field of polymer interlayers for multiple layer panels and multiple layer panels having at least one polymer interlayer sheet. Specifically, this disclosure is related to the field of high rigidity interlayers and light weight laminated multiple layer panels incorporating high rigidity interlayers.

### FIELD OF THE INVENTION

This disclosure is related to the field of polymer interlayers for multiple layer panels and multiple layer panels having at least one polymer interlayer sheet. Specifically, this disclosure is related to the field of high rigidity interlayers and light weight laminated multiple layer panels incorporating high rigidity interlayers.

### BRIEF DESCRIPTION OF THE DRAWINGS

FIG. 1 is a cross-sectional view of a tapered interlayer configured in accordance with one embodiment of the present invention, where various features of the tapered interlayer are labeled for ease of reference.

FIG. 2 is a cross-sectional view of a tapered interlayer having a tapered zone that extends over the entire width of the interlayer, wherein the entire tapered zone has a constant wedge angle and a linear thickness profile.

FIG. 3 is a cross-sectional view of a tapered interlayer having a tapered zone that extends over part of the width of the interlayer and a flat edge zone that extends over part of the width of the interlayer, wherein the tapered zone includes a constant angle zone and a variable angle zone.

FIG. 4 is a cross-sectional view of a tapered interlayer having a tapered zone that extends over part of the width of the interlayer and two flat edge zones that extend over part of the width of the interlayer, wherein the tapered zone includes a constant angle zone and two variable angle zones.

FIG. 5 is a cross-sectional view of a tapered interlayer having a tapered zone that extends over part of the width of the interlayer and two flat edge zones that extend over part of the width of the interlayer, wherein the tapered zone is formed entirely of a variable angle zones having a curved thickness profile.

FIG. 6 is a cross-sectional view of a tapered interlayer having a tapered zone that extends over the entire width of the interlayer, wherein the tapered includes three constant angle zones spaced from one another by two variable angle zones.

FIG. 7 is a cross-sectional view of a tapered interlayer having a tapered zone that extends over part of the width of the interlayer and two flat edge zones that extend over part of the width of the interlayer, wherein the tapered zone includes three constant angle zones and four variable angle zones.

FIG. 8a is a plan view of a tapered interlayer configured for use in a vehicle windshield, wherein the thickness profile of the interlayer is similar to the thickness profile of the interlayer depicted in FIG. 2.

FIG. 8b is a cross-sectional view of the interlayer of FIG. 8a, showing the thickness profile of the interlayer.

FIG. 9 is a diagram showing the three-point bending test of an embodiment and the test setup.

FIG. 10 provides a chart of the load versus the deflection of a test sheet in a three point bending test.

FIG. 11 provides a chart demonstrating the correlation of glass transition temperature of the interlayer with stiffness of the multiple layer panel.

FIG. 12 provides a chart demonstrating the correlation the improved stiffness of the disclosed multiple layer panel for various different panel thicknesses.

FIG. 13 is a chart showing the relationship between equivalent glass transition temperature (T_{eq}) and deflection stiffness for various comparative and disclosed panels.

### SUMMARY

One aspect of the present invention concerns a multilayer interlayer comprising a first polymer layer comprising a first poly(vinyl butyral) resin and at least two plasticizers. Each plasticizer is present in said first polymer layer in an amount of at least 4 parts per hundred resin (phr), and the first polymer layer has a glass transition temperature of at least 35° C. in said interlayer. The interlayer comprises a second polymer layer adjacent to and in contact with said first polymer layer. The second polymer layer comprises a second poly(vinyl butyral) resin and at least one plasticizer and the second polymer layer has a glass transition temperature of less than 20° C. in said interlayer. The interlayer has an equivalent glass transition temperature of at least 27° C.

Another aspect of the present invention concerns a multilayer interlayer comprising a first polymer layer comprising a first poly(vinyl butyral) resin and at least one plasticizer. The first polymer layer has a glass transition temperature of at least 35° C. and comprises at least 30 parts per hundred resin (phr) of the plasticizer. The first poly(vinyl butyral) resin has a residual hydroxyl content of greater than 19 weight percent. The interlayer comprises a second polymer layer adjacent to the first polymer layer in the interlayer. The second polymer layer comprises a second poly(vinyl butyral) resin and at least one plasticizer. The second poly(vinyl butyral) resin has a residual hydroxyl content that is at least 9.5 weight percent different than the residual hydroxyl content of the first poly(vinyl butyral) resin. At least one of the first and the second polymer layers has an average shear storage modulus in ⅓ octave band frequency of 2,000 to 8,000 Hz of at least 150 MPa and/or the interlayer has a weight average sound transmission loss (TL_{w}), measured between 2,000 and 8,000 Hz according to ASTM E-90 (05) at a temperature of 20° C. when laminated between two sheets of glass having dimensions of 80 cm by 50 cm and a thickness of 2.3 mm, of at least 38 dB.

Yet another aspect of the present invention concerns a multiple layer panel comprising a pair of rigid substrates and an interlayer disposed between said substrates. The interlayer comprises a first polymer layer comprising a first poly(vinyl butyral) resin and at least one plasticizer. The first polymer layer has a glass transition temperature of at least 35° C. The plasticizer is present in said first polymer layer in an amount of less than 30 parts per hundred resin (phr). The interlayer comprises a second polymer layer comprising a second poly(vinyl butyral) resin and at least one plasticizer. The plasticizer is present in said second polymer layer in an amount of at least 55 phr. The interlayer comprises a third polymer layer comprising a third poly(vinyl butyral) resin and at least one plasticizer. The second polymer layer is disposed between and in contact with each of said first and said second poly(vinyl butyral) polymer layers. The interlayer has an equivalent glass transition temperature of at least 27° C., wherein said interlayer has a sound transmission loss, measured at the coincident frequency according to ASTM E-90 (05) at a temperature of 20° C. when laminated between two sheets of glass having dimensions of 80 cm by 50 cm and a thickness of 2.3 mm, of at least 35 dB and/or a weight average sound transmission loss (TL_{w}), measured between 2,000 and 8,000 Hz according to ASTM E-90 (05) at a temperature of 20° C. when laminated between two sheets of glass having dimensions of 80 cm by 50 cm and a thickness of 2.3 mm, of at least 38 dB. The combined thickness of said rigid substrates is less than or equal to 4.0 mm.

### DESCRIPTION

Generally, multiple layer panels are comprised of two sheets of glass, or other applicable substrates, with a polymer interlayer sheet or sheets sandwiched there-between. Multiple layer panels are generally produced by placing at least one polymer interlayer sheet between two substrates to create an assembly. It is not uncommon for multiple polymer interlayer sheets to be placed within the two substrates, creating a multiple layer panel with multiple polymer interlayers. After removal of air from the assembly, the constituent parts of the assembly are preliminarily press-bonded together by a method known to one of ordinary skill in the art. A final unitary structure is formed by rendering the preliminary press bonding more permanent by a lamination process such as, but not limited to, autoclaving.

Poly(vinyl butyral) (hereinafter referred to as “PVB”) is a polymer that is commonly utilized in the manufacture of polymer interlayers and multiple layer panels. One of the main functions of multiple layer panels formed with one or more PVB interlayers is to absorb energy, such as that caused by the force of an object striking the panel, without allowing penetration through the panel or the dispersion of shards of glass. Thus, when these panels are utilized in the windows of motor vehicles, airplanes, structures, or other objects (their common applications) they have the effect of minimizing damage or injury to the persons or objects within the enclosed area of the object. In addition to the safety benefits, the polymer interlayers of multiple layer panels can be utilized to impart other advantageous effects to the panel including, but not limited to: acoustic noise attenuation, reduction of UV and/or IR light transmission, and enhancement of the general appearance and aesthetic appeal of window openings.

Recently, due, in part, to growing societal concerns over the fuel efficiency of automotive and aeronautical transportation, there has been a demand for multiple layer panels lighter in weight than traditional models. This demand arises from the fact that weight has a direct correlation with the fuel efficiency of a car or plane; heavier vehicles require more fuel to move from point A to point B. Generally, multiple layer panels comprise a large portion—about 45-68 kilograms—of the weight of modern motor vehicles. Due to aesthetic add-ons, such as sun roofs or panoramic roofs and larger windshields, the percentage of the weight of an automobile attributed to multiple layer panels is even increasing in some modern car models. A decrease in the weight of the multiple layer panels utilized in these applications would generally result in a significant decrease in the overall weight of the vehicle and a correlated increase in fuel efficiency. Most of the weight in these panels lies not in the weight of the interlayer, but in the weight of the substrates.

Traditionally, the multiple layer panels utilized for automotive applications (such as the windshield, sun or moon roof, and side and rear windows) are typically comprised of two sheets of glass of the same thickness with a PVB interlayer disposed in between. Generally, the thickness of each substrate sheet in these applications is about 2.0 mm to 2.3 mm.

Lighter weight multiple layer panels are achieved by using thinner glass of either symmetric or asymmetric substrate configurations. Current modalities utilized to achieve lighter weight multiple layer panels for windshields generally involve asymmetric substrate configurations. In these configurations, the thickness of the outboard substrate (i.e., the substrate facing the outside of the vehicle cabin) is maintained at the traditional thickness of about 2.0 mm to 2.3 mm, while the thickness of the inboard substrate (i.e., the substrate facing the interior of the cabin) is reduced. The thickness of the outboard substrate is retained at about 2.0 mm to 2.3 mm to maintain the strength of the panel to sustain the force of sand, gravel and other road debris and hazards that can impact a motor vehicle during transportation. The thickness of the inboard substrate is reduced to lower the total overall weight of the panel. The total glass thickness of asymmetric window panels for use in windshields can be configured to be as low as 3.7 mm.

While the asymmetric substrate configurations are typically used for windshields to achieve lighter weight, symmetrical substrate configurations are typically utilized in multiple layer panels in the side windows and roof windows of cars. Generally, panels used in these windows are heat strengthened in order to provide a structural and mechanically strong glazing to resist the chips and cracking which can be caused by door slamming, movement of the panels as windows are lowered and raised, movement of roof panels and the impact of small objects on the panel. The total glass thickness of symmetric window panels for use in side and roof windows can be configured to be as low as 3.6 mm.

Due to decreased overall thickness, multiple layer panels produced by asymmetric substrate configurations provide an opportunity for weight savings and, hence, improved fuel economy in automotive and aeronautical applications. For example, typically, a windshield has a surface area of approximately 1.4 m². For a traditional 2.1 mm/2.1 mm glass configuration with a conventional PVB interlayer, the total weight of the windshield is about 15.8 kg. For an asymmetric glass configuration, such as 2.1 mm/1.6 mm (which is one of the lowest combined glass thicknesses currently utilized in commercial use) the weight of the asymmetric windshield is about 14.1 kg—a 1.7 kg, 10.8% weight savings over traditional multiple layer panels.

While asymmetric multiple layer panels do result in increased weight savings, it is not without a price. One major concern is that light weight multiple layer panels produced through asymmetric modalities, while lighter, are not as strong as multiple layer panels produced through traditional methods. The mechanical strength of windshield glass, such as deflection stiffness, decreases as the thickness of the glass decreases. For example, a 3.7 mm monolithic glass panel has a 33% reduction in deflection stiffness in comparison to a 4.2 mm monolithic glass panel. Thus, the glass bending strength, glass edge strength, glass impact strength, roof strength and torsional rigidity are all reduced in these panels.

The strength of the panels used in automotive windows is important, in part, because, in today's vehicles the panels are part of the structure of the vehicle and contribute to the overall mechanical strength and rigidity of the vehicle body, especially the vehicle roof. For example, on a Ford P2000 body the torsional rigidity of the body is 24.29 kNm/angle of degree with the windshield and back glass in place and 16.44 kNm without the glass in place. See M. A. Khaleel, et al., Effect of Glazing System Parameters on Glazing System Contribution to a Lightweight Vehicle's Torsional Stiffness and Weight. International Body and Engineering Conference, Detroit, (2000) SAE paper No. 2000-01-2719 (the entire disclosure of which is incorporated herein by reference). The glass contributes to about 30% of the overall rigidity of the car. This contribution to the automotive structure is important both in normal car operations and in the event of a collision or other accident. If the strength of the multiple layer panels in the automotive windows is compromised for the sake of lower weight and greater fuel efficiency, a decrease in the structural rigidity and overall safety of the vehicle would result.

Due to all of the problems associated with asymmetrically configured multiple layer panels, there is a need in the art for a light weight multiple layer panel with improved mechanical strength, and thus improved structural rigidity and overall safety of the vehicle. It is therefore the objective of the current invention to design a light weight multiple layer panel comprising an interlayer in which the decreased mechanical strength of the panel as a result of reduced glass thickness is compensated at least in part by the interlayer.

Because of these and other problems in the art, described herein, among other things is a light weight multiple layer glass panel comprising: a first glass substrate; a second glass substrate; and at least one polymer interlayer disposed between the first glass substrate and the second glass substrate, the polymer interlayer having a glass transition temperature of greater than or equal to about 33 degrees Celsius. The combined thickness of the first glass substrate and the second glass substrate is less than or equal to about 4.0 mm. Additionally, the multiple layer glass panel has a deflection stiffness that is higher than the deflection stiffness of a multiple layer panel of the same thickness and glass configuration but with a conventional (non-stiff) interlayer, and in some embodiments, the multiple layer glass panel has a deflection stiffness that is at least 10% higher, or at least 20% higher than the deflection stiffness of a multiple layer panel of the same thickness and glass configuration but with a conventional (non-stiff) interlayer. In some embodiments, the multiple layer panel has a deflection stiffness of greater than or equal to about 300 Newtons per centimeter, greater than about 320 Newtons per centimeter, or greater than about 360 Newtons per centimeter, when the combined thickness of the first glass substrate and the second glass substrate is less than or equal to 4.0 mm, or less than or to 3.9 mm, or less than or equal to 3.7 mm.

In some embodiments, the polymer interlayer comprises plasticized poly(vinyl butyral). The combined thickness of the first glass substrate and the second glass substrate also may be less than or equal to about 3.9 mm or less than or equal to about 3.7 mm. In other embodiments, the polymer interlayer has a glass transition temperature of greater than or equal to about 35 degrees Celsius.

Also disclosed herein is a multiple layer glass panel comprising: a first glass substrate; a second glass substrate; and a multilayered interlayer disposed between the first glass substrate and the second glass substrate. The multilayered interlayer comprises: a first plasticized polymer layer having a glass transition temperature of greater than or equal to about 33 degrees Celsius; and a second plasticized polymer layer in contact with the first plasticized polymer layer, the second plasticized polymer layer having a glass transition temperature less than 30 degrees Celsius. The combined thickness of the first glass substrate and the second glass substrate is less than or equal to about 4.0 mm. The multiple layer glass panel has a deflection stiffness that is higher than the deflection stiffness of a multiple layer panel of the same thickness and glass configuration but with a conventional (non-stiff) multilayered interlayer, and in some embodiments, the multiple layer glass panel has a deflection stiffness that is at least 10% higher, or at least 20% higher than the deflection stiffness of a multiple layer panel of the same thickness and glass configuration but with a conventional (non-stiff) multilayered interlayer. In some embodiments, the multiple layer panel has a deflection stiffness of greater than or equal to about 240 Newtons per centimeter when the combined thickness of the first glass substrate and the second glass substrate is less than or equal to 4.0 mm, or less than or to 3.9 mm, or less than or equal to 3.7 mm. Additionally, the multiple layer glass panel has a sound transmission loss at the reference frequency of 3150 Hz (TL_{ref}) of greater than or equal to about 36 decibels.

In some embodiments, the first plasticized polymer layer comprises plasticized poly(vinyl butyral) and the second plasticized polymer layer comprises plasticized poly(vinyl butyral). Additionally, the panel may include a third plasticized polymer layer comprised of plasticized poly(vinyl butyral), with the second plasticized polymer layer disposed between the first plasticized polymer layer and the third plasticized polymer layer.

In other embodiments, the multiple layer glass panel has a deflection stiffness that is higher than the deflection stiffness of a multiple layer panel of the same thickness and glass configuration but with a conventional (non-stiff) interlayer, and in some embodiments, the multiple layer glass panel has a deflection stiffness that is at least 10% higher, or at least 20% higher than the deflection stiffness of a multiple layer panel of the same thickness and glass configuration but with a conventional (non-stiff) interlayer. In some embodiments, the multiple layer panel has a deflection stiffness of greater than about 250 Newtons per centimeter. In still other embodiments, the multiple layer glass panel has a deflection stiffness of greater than about 280 Newtons per centimeter when the combined thickness of the first glass substrate and the second glass substrate is less than or equal to 4.0 mm, or less than or to 3.9 mm, or less than or equal to 3.7 mm. The combined thickness of the first glass substrate and the second glass substrate also may be less than or equal to about 3.9 mm or less than or equal to about 3.7 mm. Additionally, the first plasticized polymer layer may have a glass transition temperature of greater than or equal to about 36 degrees Celsius, or the second plasticized polymer layer may have a glass transition temperature of less than or equal to about 20 degrees Celsius.

Also disclosed herein is a multiple layer glass panel comprising: a first glass substrate; a second glass substrate; and a multilayered interlayer disposed between the first glass substrate and the second glass substrate. The multilayered interlayer comprises: a first plasticized polymer layer with a residual hydroxyl content of greater than or equal to about 19 weight percent and a plasticizer content of less than or equal to about 35 phr; and a second plasticized polymer layer in contact with the first plasticized polymer layer, the second plasticized polymer layer having a residual hydroxyl content of less than or equal to about 16 weight percent and a plasticizer content of greater than or equal to about 48 phr. The combined thickness of the first glass substrate and the second glass substrate is less than or equal to about 4.0 mm, and the multiple layer glass panel has a deflection stiffness that is higher than the deflection stiffness of a multiple layer panel of the same thickness and glass configuration but with a conventional (non-stiff) interlayer, and in some embodiments, the multiple layer glass panel has a deflection stiffness that is at least 10% higher, or at least 20% higher than the deflection stiffness of a multiple layer panel of the same thickness and glass configuration but with a conventional (non-stiff) interlayer. In some embodiments, the multiple layer panel has a deflection stiffness of greater than or equal to about 240 Newtons when the combined thickness of the first glass substrate and the second glass substrate is less than or equal to 4.0 mm, or less than or to 3.9 mm, or less than or equal to 3.7 mm. Additionally, the multiple layer glass panel has a sound transmission loss (TL_{ref}) of greater than or equal to about 36 decibels.

In some embodiments, the first plasticized polymer layer comprises plasticized poly(vinyl butyral) and the second plasticized polymer layer comprises plasticized poly(vinyl butyral). Additionally, the panel may include a third plasticized polymer layer comprised of plasticized poly(vinyl butyral), with the second plasticized polymer layer disposed between the first plasticized polymer layer and the third plasticized polymer layer.

In some embodiments, the first plasticized polymer layer has a residual hydroxyl content of greater than or equal to about 20 weight percent. In other embodiments, the second plasticized polymer layer has a residual hydroxyl content of less than or equal to about 15 weight percent and a plasticizer content of greater than or equal to about 70 phr.

In some alternative embodiments, the multiple layer glass panel has a deflection stiffness that is higher than the deflection stiffness of a multiple layer panel of the same thickness and glass configuration but with a conventional (non-stiff) interlayer, and in some embodiments, the multiple layer glass panel has a deflection stiffness that is at least 10% higher, or at least 20% higher than the deflection stiffness of a multiple layer panel of the same thickness and glass configuration but with a conventional (non-stiff) interlayer. In some embodiments, the multiple layer panel has a deflection stiffness of greater than about 250 Newtons per centimeter or greater than about 280 Newtons per centimeter when the combined thickness of the first glass substrate and the second glass substrate is less than or equal to 4.0 mm, or less than or to 3.9 mm, or less than or equal to 3.7 mm. The combined thickness of the first glass substrate and the second glass substrate also may be less than or equal to about 3.9 mm or less than or equal to about 3.7 mm.

Also disclosed herein is a multiple layer glass panel comprising: a first glass substrate; a second glass substrate; and a multilayered interlayer disposed between the first glass substrate and the second glass substrate. The multilayered interlayer comprises: a first plasticized polymer layer; and a second plasticized polymer layer in contact with the first plasticized polymer layer. The multilayered interlayer has an equivalent glass transition temperature (T_{eq}), as defined below, of greater than or equal to about 29 degrees Celsius. In this embodiment, the combined thickness of the first glass substrate and the second glass substrate is less than or equal to about 4.0 mm, and the multiple layer glass panel has a deflection stiffness of that is higher than the deflection stiffness of a multiple layer panel of the same thickness and glass configuration but with a conventional (non-stiff) multilayered interlayer, and in some embodiments, the multiple layer glass panel has a deflection stiffness that is at least 10% higher, or at least 20% higher than the deflection stiffness of a multiple layer panel of the same thickness and glass configuration but with a conventional (non-stiff) multilayered interlayer. In some embodiments, the multiple layer panel has a deflection stiffness greater than or equal to about 240 Newtons per centimeter when the combined thickness of the first glass substrate and the second glass substrate is less than or equal to 4.0 mm, or less than or to 3.9 mm, or less than or equal to 3.7 mm. Additionally, the multiple layer glass panel has a sound transmission loss (TL_{ref}) of greater than or equal to about 36 decibels.

In some embodiments, the first plasticized polymer layer comprises plasticized poly(vinyl butyral) and the second plasticized polymer layer comprises plasticized poly(vinyl butyral). Additionally, the panel may include a third plasticized polymer layer comprised of plasticized poly(vinyl butyral), with the second plasticized polymer layer disposed between the first plasticized polymer layer and the third plasticized polymer layer.

In some alternative embodiments, the multiple layer glass panel has a deflection stiffness that is higher than the deflection stiffness of a multiple layer panel of the same thickness and glass configuration but with a conventional (non-stiff) interlayer, and in some embodiments, the multiple layer glass panel has a deflection stiffness that is at least 10% higher, or at least 20% higher than the deflection stiffness of a multiple layer panel of the same thickness and glass configuration but with a conventional (non-stiff) interlayer. In some embodiments, the multiple layer panel has a deflection stiffness of greater than about 250 Newtons per centimeter or greater than about 280 Newtons per centimeter when the combined thickness of the first glass substrate and the second glass substrate is less than or equal to 4.0 mm, or less than or to 3.9 mm, or less than or equal to 3.7 mm. The combined thickness of the first glass substrate and the second glass substrate also may be less than or equal to about 3.9 mm or less than or equal to about 3.7 mm.

In other embodiments, the multilayered interlayer has an equivalent glass transition temperature (T_{eq}) of greater than or equal to about 31 degrees Celsius or greater than or equal to about 34 degrees Celsius.

According to some embodiments, there is provided a multilayer interlayer comprising a first plasticized polymer layer, wherein the first plasticized polymer layer has a glass transition temperature of at least 33° C., and a second plasticized polymer layer, wherein the second plasticized polymer layer has a glass transition temperature less than 10° C. and a thickness of 5 mils or less, and wherein the interlayer has a sound transmission loss at the coincident frequency (TL_{c}) of at least 35 dB and an equivalent glass transition temperature (T_{eq}) of at least 27° C.

In some embodiments, there is provided a multilayer interlayer comprising a first polymer layer comprising a first poly(vinyl butyral) resin and at least one plasticizer; and a second polymer layer adjacent to the first polymer layer in the interlayer, wherein the second polymer layer comprises a second poly(vinyl butyral) resin and at least one plasticizer, wherein the second poly(vinyl butyral) resin has a residual hydroxyl content that is at least 6 weight percent different than the residual hydroxyl content of the first poly(vinyl butyral) resin, wherein the second polymer layer has a glass transition temperature of less than 9° C. and a maximum thickness of less than 9 mils, wherein the interlayer has a sound transmission loss at the coincident frequency (TL_{c}) of at least 35 dB and/or a weight average sound transmission loss (TL_{w}) between 2,000 and 8,000 Hz of at least 38 dB.

In some embodiments, there is provided a multilayer interlayer comprising a first polymer layer comprising a first poly(vinyl butyral) resin and at least one plasticizer, wherein said first polymer layer has a glass transition temperature of at least 33° C.; and a second polymer layer adjacent to said first polymer layer in said interlayer, wherein said second polymer layer comprises a second poly(vinyl butyral) resin and at least one plasticizer, wherein at least one of said first and said second polymer layers has an average shear storage modulus (G′) in the ⅓ octave band frequency of 2,000 to 8,000 Hz of at least 150 MPa, wherein said interlayer has a sound transmission loss at the coincident frequency (TL_{c}) of at least 35 dB and/or a weight average sound transmission loss (TL_{w}) between 2,000 and 8,000 Hz of at least 38 dB. Shear storage modulus (G′) can be determined using dynamic mechanical analysis (DMA) as described in further detail, below.

In some embodiments, there is provided a multilayer interlayer comprising a first polymer layer comprising a first poly(vinyl butyral) resin and at least one plasticizer; a second polymer layer comprising a second poly(vinyl butyral) resin and at least one plasticizer, wherein the second polymer layer has a glass transition temperature of less than 9° C.; and a third polymer layer comprising a third poly(vinyl butyral) resin and at least one plasticizer, wherein the second polymer layer is disposed between and in contact with each of the first and the second polymer layers, wherein the absolute value of the maximum difference in residual hydroxyl content between the first poly(vinyl butyral) resin and the second poly(vinyl butyral) resin, the second poly(vinyl butyral) resin and the third poly(vinyl butyral) resin, and the first poly(vinyl butyral) resin and the third poly(vinyl butyral) resin is at least 6 weight percent, wherein the ratio of the combined thicknesses of the first and the third polymer layers to the thickness of the second polymer layer is at least 2.25:1 and the total interlayer thickness is less than or equal to 90 mils, wherein the equivalent glass transition temperature (T_{eq}) of the interlayer is at least 27° C.

In some embodiments, there is provided a multilayer interlayer comprising a first polymer layer comprising a first poly(vinyl butyral) resin and at least one plasticizer, wherein the first poly(vinyl butyral) resin has a residual hydroxyl content of at least 19 weight percent; and a second polymer layer adjacent to the first polymer layer in the interlayer, wherein the second polymer layer comprises a second poly(vinyl butyral) resin and at least one plasticizer, wherein the second polymer layer has a glass transition temperature of not more than 20° C., wherein at least one of the first and the second polymer layers have an average shear storage modulus (G′) in ⅓ octave band frequency of 2,000 to 8,000 Hz of at least 150 MPa, wherein the interlayer has a sound transmission loss at the coincident frequency (TL_{c}) of at least 35 dB and/or a weighted average sound transmission loss (TL_{w}) between 2,000 and 8,000 Hz of at least 38 dB.

According to some embodiments, a multiple layer glass panel is provided that comprises a pair of rigid substrates and a multiple layer interlayer disposed between the rigid substrates, the interlayer comprising a first polymer layer comprising a first poly(vinyl butyral) resin having a residual hydroxyl content greater than 19 weight percent and at least one plasticizer, wherein the first polymer layer has a glass transition temperature of at least 33° C.; and a second polymer layer comprising a second poly(vinyl butyral) resin having a residual hydroxyl content less than 16 weight percent and at least one plasticizer, wherein the second polymer layer has a glass transition at least 20° C. lower than the glass transition temperature of the first polymer layer. Additionally, the panel has a deflection stiffness of at least 240 N/cm when the combined thickness of the rigid substrates is less than 4.0 mm, less than 3.9 mm, or less than 3.7 mm.

In other embodiments, a multiple layer panel is provided that comprises a pair of rigid substrates and an interlayer disposed between the substrates, wherein the interlayer comprises at least one polymer layer comprising at least a first poly(vinyl butyral) resin and at least one plasticizer, wherein the polymer layer has an average shear storage modulus (G′) in ⅓ octave band frequency of 2,000 to 8,000 Hz of at least 150 MPa, and wherein the interlayer has a sound transmission loss at the coincident frequency (TL_{c}) of at least 35 dB and/or a weight average sound transmission loss (TL_{w}) between 2,000 and 8,000 Hz of at least 38 dB. Additionally, the panel has a deflection stiffness of at least 240 N/cm when the combined thickness of the rigid substrates is less than 4.0 mm.

In some embodiments, there is provided a multiple layer glass panel comprising a pair of rigid substrates and an interlayer disposed between the substrates, wherein the interlayer comprises at least a first polymer layer comprising a poly(vinyl butyral) resin and at least one plasticizer and having a glass transition temperature of at least 33° C., wherein the interlayer has a sound transmission loss at the coincident frequency (TL_{c}) of at least 35 dB and/or a weight average sound transmission loss (TL_{w}), measured between 2,000 and 8,000 Hz, of at least 38 dB. Additionally, the panel has a deflection stiffness of at least 225 N/cm when the combined thickness of the rigid substrates is less than 4.0 mm.

Also described herein, among other things, are high rigidity interlayers and light weight multiple layer panels (incorporating the high rigidity interlayers) which have a significant reduction in weight from traditional multiple layer panels, without the significantly decreased strength associated with the use of thin glass combinations of either symmetric or asymmetric configurations. In one embodiment, for example, this light weight multiple layer panel is comprised of two glass or other applicable substrate panels which have a combined thickness of 4.0 mm or less and at least one interlayer having a glass transition temperature at least greater than 33° C., with the interlayer sandwiched between the two substrate panels. This resultant multiple layer panel may have a deflection stiffness at least 20% higher than the conventional multiple layer panel when used in either float or annealed glass. The light weight multiple layer panel may also have a deflection stiffness of at least 285 N/cm when used in either float or annealed glass of a combined substrate thickness of 3.7 mm.

In order to facilitate a more comprehensive understanding of the interlayers and multiple layer panels disclosed herein, the meaning of certain terms, as used in this application, will first be defined. These definitions should not be taken to limit these terms as they are understood by one of ordinary skill, but simply to provide for improved understanding of how terms are used herein.

The terms “polymer interlayer sheet,” “interlayer,” “polymer layer”, and “polymer melt sheet” as used herein, may designate a single-layer sheet or a multilayered interlayer. A “single-layer sheet,” as the names implies, is a single polymer layer extruded as one layer. A multilayered interlayer, on the other hand, may comprise multiple layers, including separately extruded layers, co-extruded layers, or any combination of separately and co-extruded layers. Thus, the multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; and a combination of at least one plural-layer sheet and at least one co-extruded sheet. In various embodiments of the present invention, a multilayered interlayer comprises at least two polymer layers (e.g., a single layer or multiple layers co-extruded) disposed in direct contact with each other, wherein each layer comprises a polymer resin. The term “resin,” as utilized herein refers to the polymeric component (e.g., PVB) removed from the mixture that results from the acid catalysis and subsequent neutralization of polymeric precursors. Generally, plasticizer, such as those discussed more fully below, is added to the resins to result in a plasticized polymer. Additionally, resins may have other components in addition to the polymer and plasticizer including; e.g., acetates, salts and alcohols.

It should also be noted that while poly (vinyl butyral) (“PVB”) interlayers are often specifically discussed as the polymer resin of the polymer interlayers in this application, it should be understood that other thermoplastic interlayers besides PVB interlayers may be used. Contemplated polymers include, but are not limited to, polyurethane, polyvinyl chloride, poly(ethylene vinyl acetate) and combinations thereof. These polymers can be utilized alone, or in combination with other polymers. Accordingly, it should be understood that when ranges, values and/or methods are given for a PVB interlayer in this application (e.g., plasticizer component percentages, thickness and characteristic-enhancing additives), those ranges, values and/or methods also apply, where applicable, to the other polymers and polymer blends disclosed herein or could be modified, as would be known to one of ordinary skill, to be applied to different materials.

The PVB resin is produced by known aqueous or solvent acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026 and Vinyl Acetal Polymers, in Encyclopedia of Polymer Science & Technology, 3rd edition, Volume 8, pages 381-399, by B.E. Wade (2003), the entire disclosures of which are incorporated herein by reference. The resin is commercially available in various forms, for example, as Butvar® Resin from Solutia Inc.

While generally referred herein as “poly(vinyl acetal)” or “poly(vinyl butyral)”), the resins described herein may include residues of any suitable aldehyde, including, but not limited to, isobutyraldehyde, as previously discussed. In some embodiments, one or more poly(vinyl acetal) resin can include residues of at least one C₁ to C₁₀ aldehyde, or at least one C₄ to C₈ aldehyde. Examples of suitable C₄ to C₈ aldehydes can include, but are not limited to, n-butyraldehyde, isobutyraldehyde, 2-methylvaleraldehyde, n-hexyl aldehyde, 2-ethylhexyl aldehyde, n-octyl aldehyde, and combinations thereof.

In many embodiments, plasticizers are added to the polymer resin to form polymer layers or interlayers. Plasticizers are generally added to the polymer resin to increase the flexibility and durability of the resultant polymer interlayer. Plasticizers work by embedding themselves between chains of polymers, spacing them apart (increasing the “free volume”) and thus significantly lowering the glass transition temperature (T_{g}) of the polymer resin, making the material softer. In this regard, the amount of plasticizer in the interlayer can be adjusted to affect the glass transition temperature (T_{g}). The glass transition temperature (T_{g}) is the temperature that marks the transition from the glassy state of the interlayer to the rubbery state. In general, higher amounts of plasticizer loading can result in lower T_{g}. In various embodiments, and as described more fully in the examples, the high rigidity interlayer comprises a layer having a glass transition temperature of greater than about 33° C.

Contemplated plasticizers include, but are not limited to, esters of a polybasic acid, a polyhydric alcohol, triethylene glycol di-(2-ethylbutyrate), triethylene glycol di-(2-ethylhexonate) (known as “3-GEH”), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, and polymeric plasticizers such as oil-modified sebacic alkyds and mixtures of phospates and adipates, and mixtures and combinations thereof. 3-GEH is particularly preferred. Other examples of suitable plasticizers can include, but are not limited to, tetraethylene glycol di-(2-ethylhexanoate) (“4-GEH”), di(butoxyethyl) adipate, and bis(2-(2-butoxyethoxy)ethyl) adipate, dioctyl sebacate, nonylphenyl tetraeethylene glycol, and mixtures thereof. In some embodiments, the contemplated plasticizer is 3-GEH, which has a refractive index of 1.442 at 25° C.

In some embodiments, other plasticizers may be used, such as a high refractive index plasticizer. As used herein, the term “high refractive index plasticizer” refers to a plasticizer having a refractive index of at least 1.460. As used herein, the values for refractive index (also known as index of refraction) of a plasticizer or a resin described herein are either measured in accordance with ASTM D542 at a wavelength of 589 nm and 25° C. or are reported in literature in accordance with ASTM D542. In various embodiments, the refractive index of the plasticizer is at least about 1.460, or greater than about 1.470, or greater than about 1.480, or greater than about 1.490, or greater than about 1.500, or greater than 1.510, or greater than 1.520. Such plasticizers may be used in one or more layers of the interlayer. If the interlayer is a three-layer interlayer, such plasticizers may be used in each of the three layers. In some embodiments, one or more high refractive index plasticizers can be used in conjunction with a plasticizer having a refractive index less than 1.460, such as, for example, 3-GEH. According to such embodiments, the refractive index of the plasticizer mixture can be at least 1.460.

High refractive index plasticizers suitable for use in one or more embodiments of the present invention can include, for example, polyadipates (RI of about 1.460 to about 1.485); epoxides (RI of about 1.460 to about 1.480); phthalates and terephthalates (RI of about 1.480 to about 1.540); benzoates (RI of about 1.480 to about 1.550); and other specialty plasticizers (RI of about 1.490 to about 1.520). Examples of the high refractive index plasticizer can include, but are not limited to, esters of a polybasic acid or a polyhydric alcohol, polyadipates, epoxides, phthalates, terephthalates, benzoates, toluates, mellitates and other specialty plasticizers, among others. Further examples of suitable plasticizers include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), ethoxylated nonylphenol, and mixtures thereof.

Generally, the plasticizer content of the polymer interlayers of this application are measured in parts per hundred resin parts (“phr”), on a weight per weight basis. For example, if 30 grams of plasticizer is added to 100 grams of polymer resin, the plasticizer content of the resulting plasticized polymer would be 30 phr. When the plasticizer content of a polymer layer is given in this application, the plasticizer content of the particular layer is determined in reference to the phr of the plasticizer in the melt that was used to produce that particular layer. In some embodiments, the high rigidity interlayer comprises a layer having a plasticizer content of less than about 35 phr and less than about 30 phr.

According to some embodiments of the present invention, one or more polymer layers described herein can have a total plasticizer content of at least about 20 phr, at least about 25 phr, at least about 30 phr, at least about 35 phr, at least about 38 phr, at least about 40 phr, at least about 45 phr, at least about 50 phr, at least about 55 phr, at least about 60 phr, at least about 65 phr, at least about 67 phr, at least about 70 phr, at least about 75 phr of one or more plasticizers. In some embodiments, the polymer layer may also include not more than about 100 phr, not more than about 85 phr, not more than 80 phr, not more than about 75 phr, not more than about 70 phr, not more than about 65 phr, not more than about 60 phr, not more than about 55 phr, not more than about 50 phr, not more than about 45 phr, not more than about 40 phr, not more than about 38 phr, not more than about 35 phr, or not more than about 30 phr of one or more plasticizers. In some embodiments, the total plasticizer content of at least one polymer layer can be in the range of from about 20 to about 40 phr, about 20 to about 38 phr, or about 25 to about 35 phr. In other embodiments, the total plasticizer content of at least one polymer layer can be in the range of from about 38 to about 90 phr, about 40 to about 85 phr, or about 50 to 70 phr.

When the interlayer includes a multiple layer interlayer, two or more polymer layers within the interlayer may have the substantially the same plasticizer content and/or at least one of the polymer layers may have a plasticizer content different from one or more of the other polymer layers. When the interlayer includes two or more polymer layers having different plasticizer contents, the two layers may be adjacent to one another. In some embodiments, the difference in plasticizer content between adjacent polymer layers can be at least about 1, at least about 2, at least about 5, at least about 7, at least about 10, at least about 20, at least about 30, at least about 35 phr and/or not more than about 80, not more than about 55, not more than about 50, or not more than about 45 phr, or in the range of from about 1 to about 60 phr, about 10 to about 50 phr, or about 30 to 45 phr. When three or more layers are present in the interlayer, at least two of the polymer layers of the interlayer may have similar plasticizer contents falling for example, within 10, within 5, within 2, or within 1 phr of each other, while at least two of the polymer layers may have plasticizer contents differing from one another according to the above ranges.

In some embodiments, one or more polymer layers or interlayers described herein may include a blend of two or more plasticizers including, for example, two or more of the plasticizers listed above. When the polymer layer includes two or more plasticizers, the total plasticizer content of the polymer layer and the difference in total plasticizer content between adjacent polymer layers may fall within one or more of the ranges above. When the interlayer is a multiple layer interlayer, one or more than one of the polymer layers may include two or more plasticizers.

In some embodiments when the interlayer is a multiple layer interlayer, at least one of the polymer layers including a blend of plasticizers may have a glass transition temperature higher than that of conventional plasticized polymer layer. This may provide, in some cases, additional stiffness to layer which can be used, for example, as an outer “skin” layer in a multiple layer interlayer.

For example, in some embodiments, at least one layer of a multilayer interlayer may include at least one poly(vinyl butyral) resin and a blend of two or more plasticizers such that the plasticizer content of the polymer layer falls within one or more of the ranges described above. In some embodiments, the total plasticizer content can be less than about 45 phr, less than about 40 phr, less than about 38 phr, less than about 35 phr, or less than about 30 phr, and the glass transition temperature of the polymer layer can be at least about 32° C., at least about 33, at least about 34, at least about 35, at least about 36, at least about 37, at least about 38, at least about 39, at least about 40° C., at least 45° C. Optionally, the poly(vinyl butyral) resin utilized in such a layer may have a high residual hydroxyl content such as, for example, a residual hydroxyl content greater than 19, greater than 19.5, greater than 20, or greater than 20.5 weight percent, or the layer can have a residual hydroxyl content, glass transition temperature, or total plasticizer content as described in one or more of the ranges herein.

In addition to plasticizers, it is also contemplated that adhesion control agents (“ACAs”) can also be added to the polymer resins to form polymer interlayers. ACAs generally function to alter the adhesion to the interlayer. Contemplated ACAs include, but are not limited to, the ACAs disclosed in U.S. Pat. No. 5,728,472, residual sodium acetate, potassium acetate, and/or magnesium bis(2-ethyl butyrate).

Other additives may be incorporated into the interlayer to enhance its performance in a final product and impart certain additional properties to the interlayer. Such additives include, but are not limited to, dyes, pigments, stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, UV stabilizers, dispersants, surfactants, chelating agents, coupling agents, adhesives, primers, reinforcement additives, and fillers, among other additives known to those of ordinary skill in the art.

One parameter used to describe the polymer resin components of the polymer interlayers of this application is residual hydroxyl content (as vinyl hydroxyl content or poly(vinyl alcohol) (“PVOH”) content). Residual hydroxyl content refers to the amount of hydroxyl groups remaining as side groups on the chains of the polymer after processing is complete. For example, PVB can be manufactured by hydrolyzing poly(vinyl acetate) to poly(vinyl alcohol), and then reacting the poly(vinyl alcohol) with butyraldehyde to form PVB. In the process of hydrolyzing the poly(vinyl acetate), typically not all of the acetate side groups are converted to hydroxyl groups. Further, the reaction with butyraldehyde typically will not result in all of the hydroxyl groups being converted into acetal groups. Consequently, in any finished PVB, there will typically be residual acetate groups (such as vinyl acetate groups) and residual hydroxyl groups (such as vinyl hydroxyl groups) as side groups on the polymer chain. Generally, the residual hydroxyl content of a polymer can be regulated by controlling the reaction times and reactant concentrations, among other variables in the polymer manufacturing process. When utilized as a parameter herein, the residual hydroxyl content is measured on a weight percent basis per ASTM D-1396.

In various embodiments, the poly(vinyl butyral) resin comprises about 8 to about 35 weight percent (wt. %) residual hydroxyl groups calculated as PVOH, about 13 to about 30 wt. % residual hydroxyl groups calculated as PVOH, about 8 to about 22 wt. % residual hydroxyl groups calculated as PVOH, or about 15 to about 22 wt. % residual hydroxyl groups calculated as PVOH; and for some of the high rigidity interlayers disclosed herein, for one or more of the layers, the poly(vinyl butyral) resin comprises greater than about 19 wt. % residual hydroxyl groups calculated as PVOH, greater than about 20 wt. % residual hydroxyl groups calculated as PVOH, greater than about 20.4 wt. % residual hydroxyl groups calculated as PVOH, and greater than about 21 wt. % residual hydroxyl groups calculated as PVOH.

In some embodiments, the poly(vinyl butyral) resin used in at least one polymer layer of an interlayer may include a poly(vinyl butyral) resin that has a residual hydroxyl content of at least about 18, at least about 18.5, at least about 18.7, at least about 19, at least about 19.5, at least about 20, at least about 20.5, at least about 21, at least about 21.5, at least about 22, at least about 22.5 weight percent and/or not more than about 30, not more than about 29, not more than about 28, not more than about 27, not more than about 26, not more than about 25, not more than about 24, not more than about 23, or not more than about 22 weight percent, measured as described above.

Additionally, one or more other polymer layers in the interlayers described herein may include another poly(vinyl butyral) resin that has a lower residual hydroxyl content. For example, in some embodiments, at least one polymer layer of the interlayer can include a poly(vinyl butyral) resin having a residual hydroxyl content of at least about 8, at least about 8.5, at least about 9, at least about 9.5, at least about 10, at least about 10.5, at least about 11, at least about 11.5, at least about 12, at least about 13 weight percent and/or not more than about 16, not more than about 15, not more than about 14, not more than about 13.5, not more than about 13, not more than about 12, or not more than about 11.5 weight percent, measured as described above.

When the interlayer includes two or more polymer layers, the layers may include poly(vinyl butyral) resins that have substantially the same residual hydroxyl content, or the residual hydroxyl contents of the poly(vinyl butyral) resins in each layer may differ from each other. When two or more layers include poly(vinyl butyral) resins having substantially the same residual hydroxyl content, the difference between the residual hydroxyl contents of the poly(vinyl butyral) resins in each layer may be less than about 2, less than about 1, or less than about 0.5 weight percent. As used herein, the terms “weight percent different” and “the difference between . . . is at least . . . weight percent” refer to a difference between two given weight percentages, calculated by subtracting one number from the other. For example, a poly(vinyl acetal) resin having a residual hydroxyl content of 12 weight percent has a residual hydroxyl content that is 2 weight percent different than a poly(vinyl acetal) resin having a residual hydroxyl content of 14 weight percent (14 weight percent—12 weight percent=2 weight percent). As used herein, the term “different” can refer to a value that is higher than or lower than another value. Unless otherwise specified, all “differences” herein refer to the numerical value of the difference and not to the specific sign of the value due to the order in which the numbers were subtracted. Accordingly, unless noted otherwise, all “differences” herein refer to the absolute value of the difference between two numbers.

When two or more layers include poly(vinyl butyral) resins having different residual hydroxyl contents, the difference between the residual hydroxyl contents of the poly(vinyl butyral) resins can be at least about 2, at least about 3, at least about 4, at least about 5, at least about 6, at least about 7, at least about 8, at least about 9, at least about 10, at least about 12, at least about 15 weight percent, measured as described above.

The resin can also comprise less than 35 wt. % residual ester groups, less than 30 wt. %, less than 25 wt. %, less than 15 wt. %, less than 13 wt. %, less than 11 wt. %, less than 9 wt. %, less than 7 wt. %, less than 5 wt. %, or less than 1 wt. % residual ester groups calculated as polyvinyl ester, e.g., acetate, with the balance being an acetal, preferably butyraldehyde acetal, but optionally including other acetal groups in a minor amount, for example, a 2-ethyl hexanal group (see, for example, U.S. Pat. No. 5,137,954, the entire disclosure of which is incorporated herein by reference). The residual acetate content of a resin may also be determined according to ASTM D-1396.

In some embodiments, at least one poly(vinyl acetal) resin may have a residual acetate content of at least about 1, at least about 3, at least about 5, at least about 7 weight percent and/or not more than about 15, not more than about 12, not more than about 10, not more than about 8 weight percent, measured as described above. When the interlayer comprises a multiple layer interlayer, two or more polymer layers can include resins having substantially the same residual acetate content, or one or more resins in various layers can have substantially different acetate contents. When the residual acetate contents of two or more resins are substantially the same, the difference in the residual acetate contents may be, for example, less than about 3, less than about 2, less than about 1, or less than about 0.5 weight percent. In some embodiments, the difference in residual acetate content between two or more poly(vinyl butyral) resins in a multiple layer interlayer can be at least about 3, at least about 5, at least about 8, at least about 15, at least about 20, or at least about 30 weight percent. When such resins are utilized in a multiple layer interlayer, the resins having different residual acetate contents may be located in adjacent polymer layers. When the multiple layer interlayer is a three-layer interlayer including a pair of outer “skin” layers surrounding, or sandwiching, an inner “core” layer, for example, the core layer may include a resin having higher or lower residual acetate content. At the same time, the resin in the inner core layer can have a residual hydroxyl content that is higher or lower than the residual hydroxyl content of the outer skin layer and fall within one or more of the ranges provided previously.

Poly(vinyl acetal) resins having higher or lower residual hydroxyl contents and/or residual acetate contents may also, when combined with at least one plasticizer, ultimately include different amounts of plasticizer. As a result, layers or domains formed of first and second poly(vinyl acetal) resins having different compositions may also have different properties within a single polymer layer or interlayer. Notably, for a given type of plasticizer, the compatibility of the plasticizer in the polymer is largely determined by the hydroxyl content of the polymer. Polymers with a greater residual hydroxyl content are typically correlated with reduced plasticizer compatibility or capacity. Conversely, polymers with a lower residual hydroxyl content typically will result in increased plasticizer compatibility or capacity. As a result, poly(vinyl acetal) resins with higher residual hydroxyl contents tend to be less plasticized and exhibit higher stiffness than similar resins having lower residual hydroxyl contents. Conversely, poly(vinyl acetal) resins having lower residual hydroxyl contents may tend to, when plasticized with a given plasticizer, incorporate higher amounts of plasticizer, which may result in a softer polymer layer that exhibits a lower glass transition temperature than a similar resin having a higher residual hydroxyl content. Depending on the specific resin and plasticizer, these trends could be reversed.

When two poly(vinyl acetal) resins having different levels of residual hydroxyl content are blended with a plasticizer, the plasticizer may partition between the polymer layers or domains, such that more plasticizer can be present in the layer or domain having the lower residual hydroxyl content and less plasticizer may be present in the layer or domain having the higher residual hydroxyl content. Ultimately, a state of equilibrium is achieved between the two resins. Generally, this correlation between the residual hydroxyl content of a polymer and plasticizer compatibility/capacity can be manipulated and exploited to allow for addition of the proper amount of plasticizer to the polymer resin and to stably maintain differences in plasticizer content within multilayered interlayers. Such a correlation also helps to stably maintain the difference in plasticizer content between two or more resins when the plasticizer would otherwise migrate between the resins.

As a result of the migration of plasticizer within an interlayer, the glass transition temperatures of one or more polymer layers may be different when measured alone or as part of a multiple layer interlayer. In some embodiments, the interlayer can include at least one polymer layer having a glass transition temperature, outside of an interlayer, of at least about 33, at least about 34, at least about 35, at least about 36, at least about 37, at least about 38, at least about 39, at least about 40, at least about 41, at least about 42, at least about 43, at least about 44, at least about 45, or at least about 46° C. In some embodiments, the same layer may have a glass transition temperature within the polymer layer of at least about 34, at least about 35, at least about 36, at least about 37, at least about 38, at least about 39, at least about 40, at least about 41, at least about 42, at least about 43, at least about 44, at least about 45, at least about 46, at least about 47° C.

In the same or other embodiments, at least one other polymer layer of the multiple layer interlayer can have a glass transition temperature less than 30° C. and may, for example, have a glass transition temperature of not more than about 25, not more than about 20, not more than about 15, not more than about 10, not more than about 9, not more than about 8, not more than about 7, not more than about 6, not more than about 5, not more than about 4, not more than about 3, not more than about 2, not more than about 1, not more than about 0, not more than about −1, not more than about −2° C., or not more than about −5° C., measured when the interlayer is not part of an interlayer. The same polymer layer may have a glass transition temperature of not more than about 25, not more than about 20, not more than about 15, not more than about 10, not more than about 9, not more than about 8, not more than about 7, not more than about 6, not more than about 5, not more than about 4, not more than about 3, not more than about 2, not more than about 1, or not more than about 0° C., when measured outside of the interlayer.

According to some embodiments, the difference between the glass transition temperatures of two polymer layers, typically adjacent polymer layers within an interlayer, can be at least about 5, at least about 10, at least about 15, at least about 20, at least about 25, at least about 30, at least about 35° C., at least about 35° C., at least about 35° C., while in other embodiments, two or more polymer layers can have a glass transition temperature within about 5, about 3, about 2, or about 1° C. of each other. Generally, the lower glass transition temperature layer has a lower stiffness than the higher glass transition temperature layer or layers in an interlayer and may be located between higher glass transition temperature polymer layers in the final interlayer construction.

For example, in some embodiments of this application, the increased acoustic attenuation properties of soft layers are combined with the mechanical strength of stiff/rigid layers to create a multilayered interlayer. In these embodiments, a central soft layer is sandwiched between two stiff/rigid outer layers. This configuration of (stiff)//(soft)//(stiff) creates a multilayered interlayer that is easily handled, can be used in conventional lamination methods and that can be constructed with layers that are relatively thin and light. The soft layer is generally characterized by a lower residual hydroxyl content (e.g., less than or equal to 16 wt %, less than or equal to 15 wt %, or less than or equal to 12 wt % or any of the ranges disclosed above), a higher plasticizer content (e.g., greater than or equal to about 48 phr or greater than or equal to about 70 phr, or any of the ranges disclosed above) and/or a lower glass transition temperature (e.g., less than 30° C. or less than 10° C., or any of the ranges disclosed above).

It is contemplated that polymer interlayer sheets as described herein may be produced by any suitable process known to one of ordinary skill in the art of producing polymer interlayer sheets that are capable of being used in a multiple layer panel (such as a glass laminate). For example, it is contemplated that the polymer interlayer sheets may be formed through solution casting, compression molding, injection molding, melt extrusion, melt blowing or any other procedures for the production and manufacturing of a polymer interlayer sheet known to those of ordinary skill in the art. Further, in embodiments where multiple polymer interlayers are utilized, it is contemplated that these multiple polymer interlayers may be formed through co-extrusion, blown film, dip coating, solution coating, blade, paddle, air-knife, printing, powder coating, spray coating or other processes known to those of ordinary skill in the art. While all methods for the production of polymer interlayer sheets known to one of ordinary skill in the art are contemplated as possible methods for producing the polymer interlayer sheets described herein, this application will focus on polymer interlayer sheets produced through the extrusion and co-extrusion processes. The final multiple layer glass panel laminate of the present disclosure are formed using processes known in the art.

Generally, in its most basic sense, extrusion is a process used to create objects of a fixed cross-sectional profile. This is accomplished by pushing or drawing a material through a die of the desired cross-section for the end product.

In the extrusion process, thermoplastic resin and plasticizers, including any of those resins and plasticizers described above, are generally pre-mixed and fed into an extruder device. Additives such as colorants and UV inhibitors (in liquid, powder, or pellet form) are often used and can be mixed into the thermoplastic resin or plasticizer prior to arriving in the extruder device. These additives are incorporated into the thermoplastic polymer resin, and by extension the resultant polymer interlayer sheet, to enhance certain properties of the polymer interlayer sheet and its performance in the final multiple layer glass panel product.

In the extruder device, the particles of the thermoplastic raw material and plasticizers, including any of those resins, plasticizers, and other additives described above, are further mixed and melted, resulting in a melt that is generally uniform in temperature and composition. Once the melt reaches the end of the extruder device, the melt is propelled into the extruder die. The extruder die is the component of the thermoplastic extrusion process which gives the final polymer interlayer sheet product its profile. Generally, the die is designed such that the melt evenly flows from a cylindrical profile coming out of the die and into the product's end profile shape. A plurality of shapes can be imparted to the end polymer interlayer sheet by the die so long as a continuous profile is present.

Notably, for the purposes of this application, the polymer interlayer at the state after the extrusion die forms the melt into a continuous profile will be referred to as a “polymer melt sheet.” At this stage in the process, the extrusion die has imparted a particular profile shape to the thermoplastic resin, thus creating the polymer melt sheet. The polymer melt sheet is highly viscous throughout and in a generally molten state. In the polymer melt sheet, the melt has not yet been cooled to a temperature at which the sheet generally completely “sets.” Thus, after the polymer melt sheet leaves the extrusion die, generally the next step in presently employed thermoplastic extrusion processes is to cool the polymer melt sheet with a cooling device. Cooling devices utilized in the previously employed processes include, but are not limited to, spray jets, fans, cooling baths, and cooling rollers. The cooling step functions to set the polymer melt sheet into a polymer interlayer sheet of a generally uniform non-molten cooled temperature. In contrast to the polymer melt sheet, this polymer interlayer sheet is not in a molten state and is not highly viscous. Rather, it is the set final-form cooled polymer interlayer sheet product. For the purposes of this application, this set and cooled polymer interlayer will be referred to as the “polymer interlayer sheet.”

In some embodiments of the extrusion process, a co-extrusion process may be utilized. Co-extrusion is a process by which multiple layers of polymer material are extruded simultaneously. Generally, this type of extrusion utilizes two or more extruders to melt and deliver a steady volume throughput of different thermoplastic melts of different viscosities or other properties through a co-extrusion die into the desired final form. The thickness of the multiple polymer layers leaving the extrusion die in the co-extrusion process can generally be controlled by adjustment of the relative speeds of the melt through the extrusion die and by the sizes of the individual extruders processing each molten thermoplastic resin material.

According to some embodiments, the total thickness of the multiple layer interlayer can be at least about 13 mils, at least about 20, at least about 25, at least about 27, at least about 30, at least about 31 mils and/or not more than about 75, not more than about 70, not more than about 65, not more than about 60 mils, or it can be in the range of from about 13 to about 75 mils, about 25 to about 70 mils, or about 30 to 60 mils. When the interlayer comprises two or more polymer layers, each of the layers can have a thickness of at least about 2, at least about 3, at least about 4, at least about 5, at least about 6, at least about 7, at least about 8, at least about 9, at least about 10 mils and/or not more than about 50, not more than about 40, not more than about 30, not more than about 20, not more than about 17, not more than about 15, not more than about 13, not more than about 12, not more than about 10, not more than about 9 mils. In some embodiments, each of the layers may have approximately the same thickness, while in other embodiments, one or more layers may have a different thickness than one or more other layers within the interlayer.

In some embodiments wherein the interlayer comprises at least three polymer layers, one or more of the inner layers can be relatively thin, as compared to the other outer layers. For example, in some embodiments wherein the multiple layer interlayer is a three-layer interlayer, the innermost layer can have a thickness of not more than about 12, not more than about 10, not more than about 9, not more than about 8, not more than about 7, not more than about 6, not more than about 5 mils, or it may have a thickness in the range of from about 2 to about 12 mils, about 3 to about 10 mils, or about 4 to about 9 mils. In the same or other embodiments, the thickness of each of the outer layers can be at least about 4, at least about 5, at least about 6, at least about 7 mils and/or not more than about 15, not more than about 13, not more than about 12, not more than about 10, not more than about 9, not more than about 8 mils, or can be in the range of from about 2 to about 15, about 3 to about 13, or about 4 to about 10 mils. When the interlayer includes two outer layers, these layers can have a combined thickness of at least about 9, at least about 13, at least about 15, at least about 16, at least about 18, at least about 20, at least about 23, at least about 25, at least about 26, at least about 28, or at least about 30 mils, and/or not more than about 73, not more than about 60, not more than about 50, not more than about 45, not more than about 40, not more than about 35 mils, or in the range of from about 9 to about 70 mils, about 13 to about 40 mils, or about 25 to about 35 mils.

According to some embodiments, the ratio of the thickness of one of the outer layers to one of the inner layers in a multiple layer interlayer can be at least about 1.4:1, at least about 1.5:1, at least about 1.8:1, at least about 2:1, at least about 2.5:1, at least about 2.75:1, at least about 3:1, at least about 3.25:1, at least about 3.5:1, at least about 3.75:1, or at least about 4:1. When the interlayer is a three-layer interlayer having an inner core layer disposed between a pair of outer skin layers, the ratio of the thickness of one of the skin layers to the thickness of the core layer may fall within one or more of the ranges above. In some embodiments, the ratio of the combined thickness of the outer layers to the inner layer can be at least about 2.25:1, at least about 2.4:1, at least about 2.5:1, at least about 2.8:1, at least about 3:1, at least about 3.5:1, at least about 4:1, at least about 4.5:1, at least about 5:1, at least about 5.5:1, at least about 6:1, at least about 6.5:1, or at least about 7:1 and/or not more than about 30:1, not more than about 20:1, not more than about 15:1, not more than about 10:1, not more than about 9:1, not more than about 8:1.

Multiple layer interlayers as described herein can comprise generally flat interlayers having substantially the same thickness along the length, or longest dimension, and/or width, or second longest dimension, of the sheet. In some embodiments, however, the multiple layer interlayers of the present invention can be tapered, or wedge-shaped, interlayers that comprise at least one tapered zone having a wedge-shaped profile. Tapered interlayers have a changing thickness profile along at least a portion of the length and/or width of the sheet, such that, for example, at least one edge of the interlayer has a thickness greater than the other. When the interlayer is a tapered interlayer, at least 1, at least 2, at least 3, at least 4 or more of the individual resin layers may include at least one tapered zone. Tapered interlayers may be particularly useful in, for example, heads-up display (HUD) panels in automotive and aircraft applications.

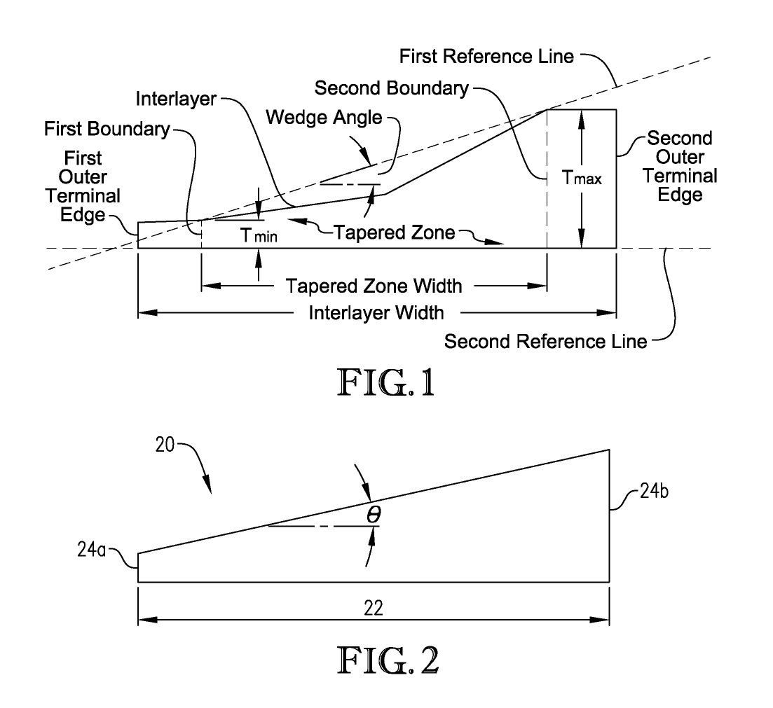

Turning now to FIGS. 1 through 8, several embodiments of tapered interlayers according to the present invention are provided. FIG. 1 is a cross-sectional view of an exemplary tapered interlayer that includes a tapered zone of varying thickness. As shown in FIG. 1, the tapered zone has a minimum thickness, Tₘᵢₙ, measured at a first boundary of the tapered zone and a maximum thickness, Tₘₐₓ, measured at a second boundary of the tapered zone. In certain embodiments, Tₘᵢₙ can be at least about 0.25, at least about 0.40, at least about 0.60 mm, or at least about 0.76 millimeters (mm) and/or not more than 1.2, not more than about 1.1, or not more than about 1.0 mm. Further, Tₘᵢₙ can be in the range of 0.25 to 1.2 mm, 0.40 to 1.1 mm, or 0.60 to 1.0 mm. In certain embodiments, Tₘₐₓ can be at least about 0.38, at least about 0.53, or at least about 0.76 mm and/or not more than 2.2, not more than about 2.1, or not more than about 2.0 mm. Further, Tₘₐₓ can be in the range of 0.38 to 2.2 mm, 0.53 to 2.1 mm, or 0.76 to 2.0 mm. In certain embodiments, the difference between Tₘₐₓ and Tₘᵢₙ can be at least about 0.13, at least about 0.15, at least about 0.20, at least about 0.25, at least about 0.30, at least about 0.35, at least about 0.40 mm and/or not more than 1.2, not more than about 0.90, not more than about 0.85, not more than about 0.80, not more than about 0.75, not more than about 0.70, not more than about 0.65, or not more than about 0.60 mm. Further, the difference between Tₘₐₓ and Tₘᵢₙ can be in the range of 0.13 to 1.2 mm, 0.25 to 0.75 mm, or 0.40 to 0.60 mm. In certain embodiments, the distance between the first and second boundaries of the tapered zone (i.e. the “tapered zone width”) can be at least about 5, at least about 10, at least about 15, at least about 20, or at least about 30 centimeters (cm) and/or not more than about 200, not more than about 150, not more than about 125, not more than about 100 or not more than about 75 cm. Further, the tapered zone width can be in the range of 5 to 200 cm, 15 to 125 cm, or 30 to 75 cm.

As shown in FIG. 1, the tapered interlayer includes opposite first and second outer terminal edges. In certain embodiments, the distance between the first and second outer terminal edges (i.e., the “interlayer width”) can be at least about 20, at least about 40, or at least about 60 cm and/or not more than about 400, not more than about 200, or not more than about 100 cm. Further the interlayer width can be in the range of 20 to 400 cm, 40 to 200 cm, or 60 to 100 cm. In the embodiment depicted in FIG. 1, the first and second boundaries of the tapered zone are spaced inwardly from the first and second outer terminal edges of the interlayer. In such embodiments, only a portion of the interlayer is tapered. When the tapered zone forms only a portion of the interlayer, the ratio of the interlayer width to the tapered zone width can be at least about 0.05:1, at least about 0.10:1, at least about 0.20:1, at least about 0.30:1, at least about 0.40:1 at least about 0.50:1, at least about 0.60:1, or at least about 0.70:1 and/or not more than about 1:1, not more than about 0.95:1, not more than about 0.90:1, not more than about 0.80:1, or not more than about 0.70:1. Further, the ratio of interlayer width to the tapered zone width can be in the range of 0.05:1 to 1:1 or 0.30:1 to 0.90:1. In an alternative embodiment, discussed below, the entire interlayer is tapered. When the entire interlayer is tapered, the tapered zone width is equal to the interlayer width and the first and second boundaries of the tapered zone are located at the first and second terminal edges, respectively.

As illustrated in FIG. 1, the tapered zone of the interlayer has a wedge angle (0), which is defined as the angle formed between a first reference line extending through two points of the interlayer where the first and second tapered zone boundaries intersect a first (upper) surface of the interlayer and a second reference line extending through two points where the first and second tapered zone boundaries intersect a second (lower) surface of the interlayer. In certain embodiments, the wedge angle of the tapered zone can be at least about 0.10, at least about 0.13, at least about 0.15, at least about 0.20, at least about 0.25, at least about 0.30, at least about 0.35, or at least about 0.40 milliradians (mrad) and/or not more than about 1.2, not more than about 1.0, not more than about 0.90, not more than about 0.85, not more than about 0.80, not more than about 0.75, not more than about 0.70, not more than about 0.65, or not more than about 0.60 mrad. Further, the wedge angle of the tapered zone can be in the range of 0.10 to 1.2 mrad, 0.13 to 1.0 mrad, 0.25 to 0.75 mrad, or 0.40 to 0.60 mrad.

When the first and second surfaces of the tapered zone are each planar, the wedge angle of the tapered zone is simply the angle between the first (upper) and second (lower) surfaces. However, as discussed in further detail below, in certain embodiments, the tapered zone can include at least one variable angle zone having a curved thickness profile and a continuously varying wedge angle. Further, in certain embodiments, the tapered zone can include two or more constant angle zones, where the constant angle zones each have a linear thickness profile, but at least two of the constant angle zones have different wedge angles.

FIGS. 2-7 illustrate various tapered interlayers configured according embodiments of the present invention. FIG. 2 depicts an interlayer 20 that includes a tapered zone 22 extending entirely from a first terminal edge 24a of the interlayer 20 to a second terminal edge 24b of the interlayer 20. In this configuration, the first and second boundaries of the tapered zone are located at the first and second terminal edges 24a,b of the interlayer. The entire tapered zone 22 of the interlayer 20 depicted in FIG. 2 has a constant wedge angle θ that is simply the angle formed between the planar first (upper) and second (lower) planar surfaces of the interlayer 20.

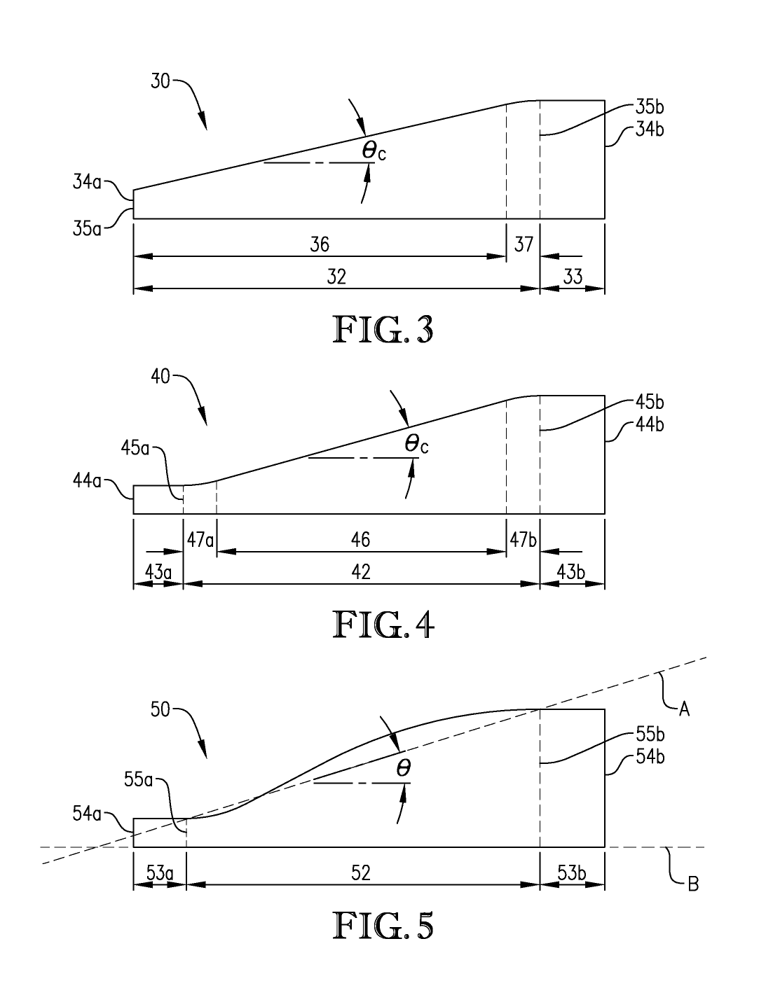

FIG. 3 illustrates an interlayer 30 that includes a tapered zone 32 and a flat edge zone 33. The first boundary 35a of the tapered zone 32 is located at the first terminal edge 34a of the interlayer 30, while the second boundary 35b of the tapered zone 32 is located where the tapered zone 32 and the flat edge zone 33 meet. The tapered zone 32 includes a constant angle zone 36 and a variable angle zone 37. The constant angle zone 36 has a linear thickness profile and a constant wedge angle, θ_{c}, while the variable angle zone 37 has a curved thickness profile and a continuously varying wedge angle. The starting wedge angle of the variable angle zone 37 is equal to the constant wedge angle θ_{c} and the ending wedge angle of the variable angle zone 37 is zero. The interlayer 30 depicted in FIG. 3 has a constant wedge angle θ_{c} that is greater than the overall wedge angle of the entire tapered zone 32.

FIG. 4 illustrates an interlayer 40 that includes a tapered zone 42 located between first and second flat edge zones 43a,b. The first boundary 45a of the tapered zone 42 is located where the tapered zone 42 and the first flat edge zone 43a meet, while the second boundary 45b of the tapered zone 42 is located where the tapered zone 42 and the second flat edge zone 43b meet. The tapered zone 42 includes a constant angle zone 46 located between first and second variable angle zones 47a,b. The first variable angle zone 47a forms a transition zone between the first flat edge zone 43a and the constant angle zone 46. The second variable angle zone 47b forms a transition zone between the second flat edge zone 43b and the constant angle zone 46. The constant angle zone 46 has a linear thickness profile and a constant wedge angle, θ_{c}, while the first and second variable angle zones 47a,b have curved thickness profiles and continuously varying wedge angles. The starting wedge angle of the first variable angle zone 47a is equal to zero and the ending wedge angle of the first variable angle zone 47b is equal to the constant wedge angle θ_{c}. The starting wedge angle of the second variable angle zone 47b is equal to the constant wedge angle θ_{c} and the ending wedge angle of the second variable angle zone 47b is zero. The interlayer 40 depicted in FIG. 4 has a constant wedge angle θ_{c} that is greater than the overall wedge angle of the entire tapered zone 42.

FIG. 5 illustrates an interlayer 50 that includes a tapered zone 52 located between first and second flat edge zones 53a,b. The tapered zone 52 of the interlayer 50 does not include a constant angle zone. Rather, the entire tapered zone 52 of the interlayer 50 is a variable angle zone having a curved thickness profile and a continuously varying wedge angle. As described above, the overall wedge angle, θ, of the tapered zone 52 is measured as the angle between a first reference line “A” extending through the two points where the first and second boundaries 55a,b of the tapered zone 52 meet the first (upper) surface of the interlayer 50 and a second reference line “B” extending through the two points where the first and second boundaries 55a,b of the tapered zone 52 meet the second (lower) surface of the interlayer 50. However, within the tapered zone 52, the curved thickness profile provides an infinite number of wedge angles, which can be greater than, less than, or equal to the overall wedge angle θ of the entire tapered zone 52.

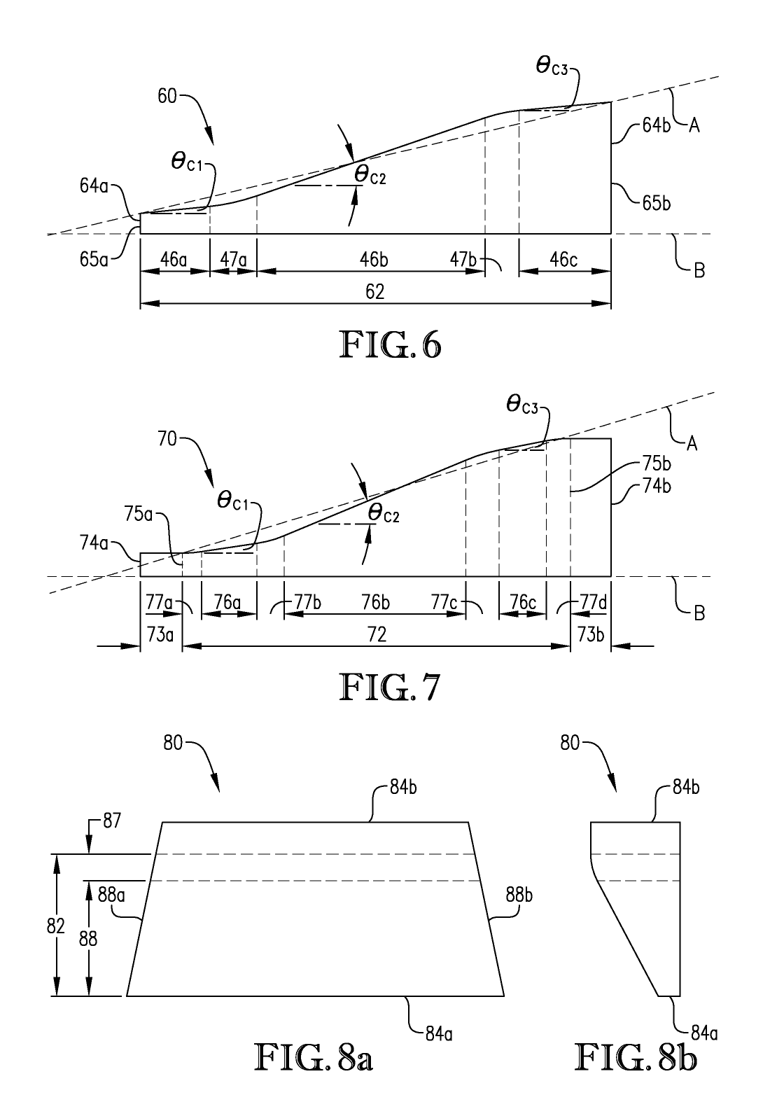

FIG. 6 illustrates an interlayer 60 that does not include any flat end portions. Rather, the tapered zone 62 of the interlayer 60 forms the entire interlayer 60. Thus, the first and second boundaries 65a,b of the tapered zone 60 are located at the first and second terminal edges 64a,b of the interlayer 60. The tapered zone 62 of the interlayer 60 includes first, second, and third constant angle zones 46a-c separated by first and second variable angle zones 47a,b. The first, second, and third constant angle zones 46a-c each have a linear thickness profile and each have unique first, second, and third constant wedge angles, θ_{c1},θ_{c2},θ_{c3}, respectively The first variable angle zone 47a acts as a transition zone between the first and second constant angle zones 46a,b. The second variable angle zone 47b acts as a transition zone between the second and third constant angle zones 46b,c. As discussed above, the overall wedge angle, θ, of the tapered zone 62 is measured as the angle between a first reference line “A” and a second reference line “B.” The first constant wedge angle θ_{d} is less than the overall wedge angle θ of the tapered zone 62. The second constant wedge angle θ_{c2} is greater the overall wedge angle θ of the tapered zone 62. The third constant wedge angle θ_{c3} is less than the overall wedge angle θ of the tapered zone 62. The wedge angle of the first variable angle zone 47a continuously increases from the first constant wedge angle θ_{di} to the second constant wedge angle, θ_{c2}. The wedge angle of the second variable angle zone 47b continuously decreases from the second constant wedge angle θ_{c2} to the third wedge angle θ_{c3}.

FIG. 7 illustrates an interlayer 70 that includes a tapered zone 72 located between first and second flat edge zones 73a,b. The first and second boundaries 75a,b of the tapered zone 72 are spaced inwardly from the first and second outer edges 74a,b of the interlayer 70. The tapered zone 72 of the interlayer 70 includes first, second, third, and fourth variable angle zones 77a-d and first, second, and third constant angle zones 76a-c. The first variable angle zone 77a acts as a transition zone between the first flat edge zone 73a and the first constant angle zone 76a. The second variable angle zone 77b acts as a transition zone between the first constant angle zone 76a and the second constant angle zone 76b. The third variable angle zone 77c acts as a transition zone between the second constant angle zone 76b and the third constant angle zone 76c. The fourth variable angle zone 77d acts as a transition zone between the third constant angle zone 76c and the second flat edge zone 73b. The first, second, and third constant angle zones 76a-c each have a linear thickness profile and each have unique first, second, and third constant wedge angles, θ_{c1},θ_{c2},θ_{c3}, respectively As discussed above, the first, second, third, and fourth variable angle zones 77a-d have wedge angles that continuously transition from the wedge angle of the constant angle zone on one side of the variable angle zone 77 to the wedge angle of the constant angle zone on the other side of the variable angle zone 77.

As discussed above, the tapered interlayer can include one or more constant angle tapered zones, each having a width that is less than the overall width of the entire tapered zone. Each tapered zone can have a wedge angle that is the same as or different than the overall wedge angle of the entire tapered zone. For example, the tapered zone can include one, two, three, four, five or more constant angle tapered zones. When multiple constant angle tapered zones are employed, the constant angle tapered zones can be separated from one another by variable angle tapered zones that serve to transition between adjacent constant angle tapered zones.

In certain embodiments, the width of each constant angle tapered zone can be at least about 2, at least about 5, at least about 10, at least about 15, or at least about 20 cm and/or not more than about 150, not more than about 100, or not more than about 50 cm. In certain embodiments, the ratio of the width of each constant angle tapered zone to the overall width of the entire tapered zone can be at least about 0.1:1, at least about 0.2:1, at least about 0.3:1 or at least about 0.4:1 and/or not more than about 0.9:1, not more than about 0.8:1, not more than about 0.7:1, not more than about 0.6:1, or not more than about 0.5:1.

In certain embodiments, the wedge angle of each constant angle tapered zone can be at least about 0.13, at least about 0.15, at least about 0.20, at least about 0.25, at least about 0.30, at least about 0.35, at least about 0.40 mrad and/or not more than about 1.2, not more than about 1.0, not more than about 0.90, not more than about 0.85, not more than about 0.80, not more than about 0.75, not more than about 0.70, not more than about 0.65, or not more than about 0.60 mrad. Further, the wedge angle of each constant angle tapered zone can be in the range of 0.13 to 1.2 mrad, 0.25 to 0.75 mrad, or 0.40 to 0.60 mrad. In certain embodiments, the wedge angle of at least one constant angle tapered zone is at least about 0.01, at least about 0.05, at least about 0.10, at least about 0.20, at least about 0.30, or at least about 0.40 mrad greater than the overall wedge angle of the entire tapered zone. In certain embodiments, the wedge angle of at least one constant angle tapered zone is at least about 0.01, at least about 0.05, at least about 0.10, at least about 0.20, at least about 0.30, or at least about 0.40 mrad less than the overall wedge angle of the entire tapered zone. In certain embodiments, the wedge angle of at least one constant angle tapered zone is not more than about 0.40, not more than about 0.30, not more than about 0.20, not more than about 0.10, not more than about 0.05, or not more than about 0.01 mrad greater than the overall wedge angle of the entire tapered zone. In certain embodiments, the wedge angle of at least one constant angle tapered zone is not more than about 0.40, not more than about 0.30, not more than about 0.20, not more than about 0.10, not more than about 0.05, or not more than about 0.01 mrad less than the overall wedge angle of the entire tapered zone.

FIGS. 8a and 8b illustrate an interlayer 80 that is similar in thickness profile to the interlayer 30 of FIG. 3. The interlayer 80 of FIGS. 8a and 8b is configured for use in a vehicle windshield by fixing the interlayer between two sheets of glass. As depicted in FIG. 8a, the first terminal edge 84a of the interlayer 80 can be located at the bottom of the windshield, while the second terminal edge 84b of the interlayer 80 can be located at the top of the windshield. The tapered zone 82 of the interlayer 80 is positioned in an area of the windshield where a heads-up display is to be located. The tapered zone 82 of interlayer 80 includes a constant angle zone 86 and a variable angle zone 87. As depicted in FIG. 8a, in certain embodiments, the tapered zone 82 extends entirely across the interlayer 80 between a first side edge 88a and a second side edge 88b of the interlayer 80. FIG. 8b, which is similar to FIG. 3, shows the thickness profile of the interlayer 80 between the bottom of the windshield and the top of the windshield.

As noted above, the interlayers of the present disclosure may be used as a single-layer sheet or a multilayered sheet. In various embodiments, the interlayers of the present disclosure (either as a single-layer sheet or as a multilayered sheet) can be incorporated into a multiple layer panel, and most commonly, disposed between two substrates. The two substrate panels of the disclosed multiple layer panel can be comprised of glass, plastic, or any other applicable substrate known for the production of multiple layer panels, but are most commonly comprised of glass. An example of such a construct would be: (glass)//(interlayer)//(glass). In an embodiment where the substrates are comprised of glass, it is contemplated that the glass may be annealed, heat strengthened or tempered. Further, the two substrates may be of the same thickness (e.g., 2 mm and 2 mm) or may be of an asymmetric thickness (e.g., 1.5 mm and 2.5 mm). All that is determinative is that the combined thickness of the panels be 4.0 mm or less. In one embodiment, the combined thickness of the substrates for the multiple layer glass panel will be 3.7 mm or lower for panels that will be utilized in windshield applications, 3.7 mm or lower for panels that will be utilized in side and rear window applications and 4.0 mm or lower for panels that will be utilized in roof window applications. In some embodiments, the glass panels or other rigid substrates used in forming the multiple layer panels can have a combined thickness of less than 3.95, less than 3.85, less than 3.75, less than 3.65, less than 3.5 mm, less than 3 mm, or less than 2.5 mm. At least one, or both, of the substrates can have a thickness of less than 2.1, less than 2.0, less than 1.9, less than 1.8, less than 1.7, less than 1.6, or less than 1.5 mm.

Without any intention of being limited to any theory or mechanism of operation, the reason why this multiple layer glass panel has improved strength, even in embodiments with panels with reduced glass thickness through asymmetric or symmetric configuration, is because the interlayer of this multiple layer panel contributes to the overall strength of the panel. This is because the interlayer having high stiffness in this multiple layer panel provides a significant membrane stress to the maximum flexural rigidity in the event of a bending.

The inclusion of an interlayer with high stiffness in the disclosed multiple layer panel creates a multiple layer panel with greater strength than a multiple layer panel with a conventional interlayer with the same type and thickness of substrate panels. This is because the interlayer of the disclosed multiple layer panel, in contrast to conventional interlayers, contributes more to the overall strength and rigidity of the panel. Thus, in contravention to conventional wisdom, the thickness of the multiple layer panel can be reduced without decreasing the strength of the panel.

For the purpose of the present disclosure, a conventional interlayer such as conventional PVB (designated as “Conventional Interlayer” or “Conventional PVB”) is an interlayer containing a single-layered or monolithic interlayer such as a monolithic PVB interlayer and exhibiting a glass transition temperature of about 30° C. The Conventional PVB can be produced from PVB resin and plasticizer content as indicated in Table 1 below. The Conventional PVB can also be made with PVB resin of different hydroxyl content and plasticizer of different content to satisfy the glass transition temperature of about 30° C. Conventional acoustic multilayered interlayer such as conventional acoustic multilayered PVB interlayer (designated as “Conventional Acoustic PVB”) is an interlayer comprising at least one layer of conventional PVB (i.e., Conventional PVB) and at least one layer of soft or acoustic PVB (exhibiting a glass transition temperature of less than 30° C.).

Glass laminates using interlayers of the present disclosure can be prepared by known procedures. The polymer interlayer and glass are assembled and heated to a glass temperature of about 25° C. to 60° C. and then passed through a pair of nip rolls to expel trapped air to form an assembly. The compressed assembly is then heated, for example by infrared radiation or in a convection oven, to a temperature of about 70° C. to 120° C. The heated assembly is then passed through a second pair of nip rolls followed by autoclaving the assembly at about 130° C. to 150° C. and about 1,000 to 2,000 kilopascals (kPa) for about 30 minutes. Non-autoclave methods, such as those disclosed in U.S. Pat. No. 5,536,347 (the entire disclosure of which is incorporated herein by reference), are also useful. Further, in addition to the nip rolls, other means for use in de-airing of the interlayer-glass interfaces known in the art and that are commercially practiced include vacuum bag and vacuum ring processes in which a vacuum is utilized to remove the air.

In order to help comprehend the interlayer of the present disclosure, it is also useful to have an understanding of the properties and characteristics associated with a polymer interlayer sheet and formulas by which these properties and characteristics of a polymer interlayer sheet are measured. One quantitative way to determine the contribution of the PVB interlayer with high stiffness to the overall strength and rigidity of the multiple layer panel is the “deflection stiffness.” The deflection stiffness is determined by a three point bending method which tests the edge strength, stiffness, flexural modulus and mechanical rigidity of the panel. In this method, a polymer interlayer test sheet is laminated between two substrates to form a panel. In one embodiment, a polymer interlayer test sheet with a thickness of about 0.76 millimeters is laminated between two panes of glass each having a thickness of 2.3 millimeters, a width of 2.54 centimeters, and a length of 30.5 centimeters. These thicknesses, widths, and lengths of the interlayer and glass are merely exemplary and not limiting. For example, differing glass thicknesses and configurations (e.g., asymmetric) are also commonly tested with the three point bending method.

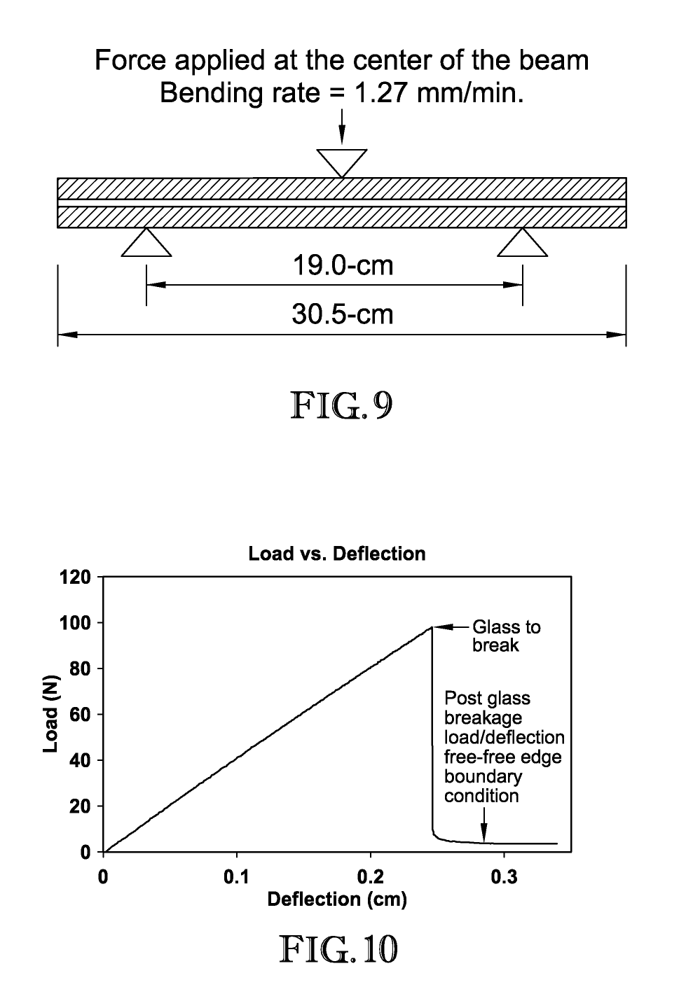

After the lamination process, the panel is then conditioned in a constant humidity (50%) and temperature (23° C.) setting for one to two hours before being subjected to the bending test. In this test, two fixed supports with a span of 19.0 centimeters are applied to the underside of the panel. A third point, a cylindrical rod, with a diameter of 0.953 centimeters and length of 5.08 centimeters, is applied at the upperside of the panel, generally at the center of the panel. Then a force is applied at the third point to create a constant velocity of about 1.27 mm/min on the test panel. A diagram of an embodiment of this three point bending test is provided in FIG. 9. Values for the load on the test panel (measured in Newtons, N) and the deflection of the test panel (measured in centimeters, cm) are recorded. These values are then plotted against each other, as seen in FIG. 10, to determine the stiffness of the laminate (deflection stiffness, measured in N/cm) which is equal to the average slope of the line created by plotting the load versus the deflection of the panel prior to breakage of glass or apparent drop in the load, i.e., the maximum load prior to breakage or apparent drop in the load divided by the corresponding deflection. In some embodiments, multiple layer panels constructed according to the present invention can have a deflection stiffness of at least about 225, at least about 240, at least about 250, at least about 265, at least about 275, at least about 280, at least about 300, at least about 310, at least about 325, at least about 350 N/cm, measured as described above.

Another key performance indicator of multilayer glass laminate panels is penetration resistance. Penetration resistance is normally determined via the 2.27 kg (5 lb.) ball drop test wherein a Mean Break Height (MBH) can be measured. Penetration resistance can be measured by the staircase method. Automotive windshields for use in vehicles in the United States must pass the minimum penetration resistance specification (80% pass at 12 feet) found in the ANSI Z26.1 code. In other parts of the world, there are similar codes that are required to be met. There are also specific code requirements in both the US and Europe for use of laminated glass in architectural applications wherein minimum penetration resistance must be met.

The staircase method utilizes an impact tower from which the steel ball can be dropped from various heights onto a 30.5 cm×30.5 cm sample. The MBH is defined as the ball drop height at which 50% of the samples would hold the ball and 50% would allow penetration through the sample. The test laminate is supported horizontally in a support frame similar to that described in the ANSI Z26.1 code. If necessary an environmental chamber is used to condition laminates to the desired test temperature. The test is performed by supporting the sample in the support frame and dropping a ball onto the laminate sample from a height near the expected MBH. If the ball penetrates the laminate, the result is recorded as a failure, and if the ball is supported (that is, does not penetrate the sample), the result is recorded as a hold. If the result is a hold, the process is repeated from a drop height 0.5 m higher than the previous test. If the result is a failure, the process is repeated at a drop height 0.5 m lower than the previous test. This procedure is repeated until all of the test samples have been used. The results are then tabulated and the percent hold at each drop height is calculated. These results are then graphed as percent hold versus height and a line representing the best fit of the data is drawn on the graph. The MBH can then be read from the graph at the point where the percent hold is 50%. In general, ten to twelve samples are used in the test to generate each MBH data point. The samples are laminated using 2.3 mm thick clear glass (commercially available from Pittsburgh Glass Works of Pennsylvania) and autoclaved using the conditions described herein. As used herein, the disclosed MBH data are obtained by the above method at a temperature of 23° C.

In some embodiments, multiple layer panels as described herein can have a MBH of at least about 4.5 m, at least about 5.0 m, at least about 5.5 m, measured according to the staircase method. In other embodiments, the panels may have an MBH less than 5.5 m, although such a value may not be suitable for panels used in windshield and other applications requiring high impact strength. For windshield application, an MBH of 5.5 m or higher at 23° C. is considered to be acceptable to meet minimum penetration resistance over a temperature range specified in the ANSI Z26.1 code and codes or norms used in other parts of the world.

Multiple layer panels of the present invention can exhibit enhanced acoustic performance, as evidenced by, for example, higher sound transmission loss. Overall, the sound transmission loss, both at the coincident frequency of the rigid substrate and as a weighted average over the coincident frequency region, exhibited by panels configured according to embodiments of the present invention is unexpected, especially for panels having a combined substrate thickness of 4.0 mm or less, or within any of the ranges provided above. In general, panels made from thinner substrates and with stiffer polymer layers tend to exhibit poorer sound performance. However, the multiple layer panels configured according to embodiments of the present invention, even those including thinner substrates and/or stiffer polymer layers, have sound transmission losses similar to, or better than, comparative conventional multiple layer panels formed with softer interlayers and/or thicker substrates.

The acoustic attenuation as used to characterize glass laminates consisting of the multiple layered interlayers of the present invention is determined by sound transmission loss at the frequency corresponding to the coincident frequency of a reference monolithic glass panel of 4.8 millimeters ( 3/16 inches) thickness.

For purposes of the present invention a “coincident frequency” means the frequency at which a panel exhibits a dip in sound transmission loss due to “coincident effect”. The coincident frequency can be represented by the following equation:

f_{c}=c²/2π×[ρₛ/B]^{1/2},

wherein c is the sound speed in air, ρₛ is the surface density of the glass panel, and B is the bending stiffness of glass panel. In general, the coincident frequency increases with decreasing thickness of the glass panel.

The coincident frequency (f_{c}) of the reference panel is typically in the range of 2,000 to 6,000 Hertz, and can be estimated from the algorithm:

$${f}_{c} = \frac{15 , 000}{d}$$

where “d” is the total glass thickness in millimeters and “f_{c}” is in Hertz.

For reference panels of fixed dimensions and laminates/multiple layer panels of the present disclosure, the reduction in sound transmission (i.e., sound transmission loss) is determined in accordance with ASTM E90 (05) at a fixed temperature of 20° C. The dimension of the test panel is 80 centimeters in length, 50 centimeters in width, and the thickness of the reference panel and the combined thickness of glass for the multiple layered interlayer panels are indicated in Table 2. The measured coincident frequency of the reference panel (4.8 mm monolithic glass) is at 3,150 Hz. Sound transmission loss at the reference frequency (TL_{ref}) for the conventional panels and the panels of present inventions are shown in Table 2. In addition to the reduction in sound transmission at the reference frequency (TL_{ref}), in some embodiments, the reduction in sound transmission of a panel at its coincident frequency (TL_{c}) is also used to characterize the sound performance of the panel.

In addition to the sound transmission loss at the coincident frequency (TL_{c}), the sound performance of a multiple layer panel can also be characterized by determining the weighted average sound transmission loss (TL_{w}), measured in the coincident frequency region. The weighted average sound transmission loss (TL_{w}) of a multiple layer panel over a given frequency range can be obtained from the following equation:

$${TL}_{w} = 10 \times log ( ( {\sum }_{i = 1}^{k} {10}^{{TL}_{i} / 10} ) / k )$$

wherein TLᵢ is the transmission loss, measured according to ASTM E-90 (05) at a fixed temperature of 20° C., for each ⅓ octave frequency band within the desired frequency region, wherein i ranges from 1 to k, and wherein k corresponds to the number of ⅓ octave bands. In one embodiment, when the weighted average sound transmission loss (TL_{w}) is measured over a frequency region 2,000 and 8,000 Hz, k is 7. In general, interlayers or panels with a higher sound transmission loss at the coincident frequency and/or higher weighted average sound transmission loss will have better acoustic performance than panels having lower sound transmission loss at the coincident frequency (TL_{c}) and/or lower weighted average sound transmission loss (TL_{w}). The values for sound transmission loss at the coincident frequency (TL_{c}) and the weighted average sound transmission loss (TL_{w}) provided herein were obtained using test glass panel of dimension of 50 cm by 80 cm made with two sheets of 2.3 mm clear glass and the interlayer of interest.

In various embodiments of the present disclosure, the multilayered interlayers, when laminated between two panes of glass, exhibit reductions in transmission of sound as conventional acoustic interlayers, with the sound transmission loss (TL_{ref}) generally greater than 35 decibels (dB) and greater than 36 dB. In other embodiments of the present disclosure, the multilayered interlayers, when laminated between two panes of glass, exhibit the same reduction in transmission of sound as conventional acoustic interlayers, with the sound transmission loss (TL_{ref}) generally greater than about 39 dB. In some embodiments, the interlayers described herein can have a sound transmission loss at the coincident frequency (TL_{c}) of at least about 35 dB, at least about 36, at least about 36.5, at least about 37, at least about 37.5, at least about 38, at least about 38.5, at least about 39, at least about 39.5, at least about 40, at least about 40.5, at least about 41, at least about 41.5, or at least about 42 dB, measured as described above. In the same or other embodiments, the interlayers described herein may have a weighted average sound transmission loss (TL_{w}), over a frequency range of 2,000 to 8,000 Hz, of at least about 38, at least about 38.5, at least about 39, at least about 39.5, at least about 40, at least about 40.5, at least about 41, at least about 41.5, at least about 42 dB, at least about 42.5 dB, measured as described above.

In some embodiments, interlayers of the present invention may have, for example, an inner “core” layer having a glass transition temperature of less than 9° C. and thickness of less than 9 mils, but, when laminated between two sheets of glass having a combined thickness of not more than about 4.0 mm, not more than about 3.9 mm, not more than about 3.8 mm, not more than about 3.7 mm, or not more than about 3.6 mm, the interlayers may exhibit a sound transmission loss at the coincident frequency (TL_{c}) of at least about 35, at least about 36, at least about 36.5, at least about 37, at least about 37.5, at least about 38, at least about 38.5, at least about 39, at least about 39.5, at least about 40, at least about 40.5, at least about 41, at least about 41.5, at least about 42 dB and/or a weighted average sound transmission loss (TL_{w}) of at least about 38, at least about 38.5, at least about 39, at least about 39.5, at least about 40, at least about 40.5, at least about 41, at least about 41.5, at least about 42 dB, at least about 42.5 dB, each measured as described above. Such interlayers may have, for example, a core layer glass transition temperature, an equivalent glass transition temperature (T_{eq}), an inner layer thickness, and/or a deflection stiffness within one or more ranges provided herein.

In some embodiments, the enhanced acoustic performance of the interlayers and/or panels described herein may unexpectedly be coupled with interlayers having stiffer polymer layers than many conventional acoustic interlayers or panels. For example, in some embodiments, interlayers exhibiting a TL_{c} and/or TL_{w} within the ranges above may also have an average shear storage modulus (G′), measured over the ⅓ octave band frequency of 2,000 and 8,000 Hz of at least about 150 MPa, at least about 155 MPa, at least about 160 MPa, at least about 165 MPa, at least about 170 MPa, at least about 175 MPa, at least about 180 MPa, at least 190 MPa, measured as described above.

In some embodiments, interlayers of the present invention may have a deflection stiffness or mean break height within the ranges described above, but can still exhibit a sound transmission loss at the coincident frequency (TL_{c}) of at least about 35, at least about 36, at least about 36.5, at least about 37, at least about 37.5, at least about 38, at least about 38.5, at least about 39, at least about 39.5, at least about 40, at least about 40.5, at least about 41, at least about 41.5, at least about 42 dB and/or a weighted average sound transmission loss (TL_{w}) of at least about 38, at least about 38.5, at least about 39, at least about 39.5, at least about 40, at least about 40.5, at least about 41, at least about 41.5, at least about 42, or at least about 42.5 dB, each measured as described above. Such a combination of properties may also be possible even with a thinner, low glass transition temperature core layer having, for example, a thickness of less than 9 mils. In some embodiments, the combined thickness of the stiffer skin layers can be at least about 15 mils, at least about 20 mils, at least about 23 mils, or at least about 25 mils.

The glass transition temperature is also used to describe the polymer interlayers of the present disclosure. The glass transition temperature (T_{g}) is determined by dynamic mechanical analysis (DMA). The DMA measures the shear storage (elastic) modulus (G′) in Pascals, loss (viscous) modulus (G″) in Pascals, loss (damping) factor (LF) [tan(delta)] of the specimen as a function of temperature at a given frequency, and temperature sweep rate. The polymer sheet sample is tested in shear mode at an oscillation frequency of 1 Hertz as the temperature of the sample is increased from −20° C. to 70° C. at a rate of 2° C./minute. The T_{g} is then determined by the position of the loss factor peak on the temperature scale in ° C.

To further define the multilayered interlayer comprising at least one high stiffness layer and one acoustic attenuating layer, equivalent glass transition temperature (T_{eq}) of the interlayer is used. The equivalent glass transition temperature (T_{eq}) of the above two layers is defined as:

$${T}_{eq} = \frac{( {T}_{g 1} \times {w}_{1} ) + ( {T}_{g 2} \times {w}_{2} )}{{w}_{1} + {w}_{2}}$$

where T_{g1} is the glass transition temperature of the high rigidity layer, w₁ is the thickness of the high rigidity layer, T_{g2} is the glass transition temperature of the acoustic attenuating layer, and w₂ is the thickness of the acoustic attenuating layer.

For the multilayered interlayer comprising additional layers in addition to a high stiffness layer and an acoustic attenuating layer, the equivalent glass transition is defined as the sum of the glass transition temperature of each layer multiplied by the thickness of the corresponding layer and dividing this sum by the total thickness of the interlayer.

In one embodiment, the interlayers of the present invention can have an equivalent glass transition temperature (T_{eq}) of at least about 26, at least about 26.5, at least about 27, at least about 27.5, at least about 28, at least about 28.5, at least about 29, at least about 29.5, at least about 30, at least about 30.5, at least about 31, at least about 31.5, at least about 32, at least about 32.5, at least about 33, or at least about 33.5° C. The interlayer may also have an equivalent glass transition temperature (T_{eq}) that is not more than about 75, not more than about 60, not more than about 45, not more than about 42, not more than about 40° C., or not more than about 38° C., measured as described above. In some embodiments, the interlayer can have an equivalent glass transition temperature (T_{eq}) in the range of from about 26 to about 75° C., about 27 to about 60° C., about 28 to about 45° C. or about 29 to about 42° C. According to embodiments of the present invention, interlayers having an equivalent glass transition temperature (T_{eq}) as described herein may have a total thickness and individual layers having thicknesses within the ranges provided above.

It is possible that the interlayers having an equivalent glass transition temperature (T_{eq}) in one or more of the ranges above may be utilized in multiple layer panels having a reduced thickness, as compared to conventional panels. For example, in some embodiments, an interlayer having an equivalent glass transition temperature (T_{eq}) of at least about 26, at least about 26.5, at least about 27, at least about 27.5, at least about 28, at least about 28.5, at least about 29, at least about 29.5, at least about 30, at least about 30.5, at least about 31, at least about 31.5, at least about 32, at least about 32.5, at least about 33, or at least about 33.5° C. may be used in a multiple layer panel comprising a pair of rigid substrates, such a glass substrates, having a combined thickness of not more than about 4.0, not more than about 3.9, not more than about 3.8, not more than about 3.7, not more than about 3.6, not more than about 3.5 mm. In some embodiments, each of the substrates may have the same thickness, while, in other embodiments, one of the substrates may have a thickness different from the other. Despite having enhanced impact strength and thinner substrate thickness, the interlayers configured as described above may also exhibit enhanced acoustic performance, as shown by the TL_{c} and/or TL_{w} described above. Further, such enhanced acoustic performance may also be possible with a thinner soft core layer, such as, for example, a core layer having a maximum thickness of not more than 9 mils.

### EXAMPLES

### Example 1

Multiple layer panels of differing glass configuration thicknesses were constructed with the disclosed high rigidity interlayer monolithic (i.e., single-layer) interlayers (designated as “Stiff PVB-1” and “Stiff PVB-2” and as shown in Table 1) with an interlayer thickness of about 0.76 mm. Similarly, multiple layer panels of differing glass configuration thicknesses were constructed with acoustic monolithic interlayers (designated as “Soft PVB” and as shown in Table 1) and conventional monolithic interlayers (designated as “Conventional PVB” and as shown in Table 1) with interlayer thicknesses of about 0.76 mm. All the multiple layer glass panels were subjected to the three point bending test method to determine deflection stiffness.

TABLE 1

| | | Plasticizer | | | Deflec- |
|---|---|---|---|---|---|
| | PVOH | (3-GEH) | Glass | Glass | tion |
| | content | Content | Transition | Config- | Stiff- |
| Type of | in PVB | (phr) in | Temperature | uration | ness |
| interlayer | (wt %) | PVB | (° C.) | (mm) | (N/cm) |
| Soft PVB | 16 | 48 | 20 | 2.3/2.3 | 288 |
| | | | | 2.1/2.1 | 244 |
| | | | | 2.3/1.6 | 206 |
| | | | | 2.1/1.6 | 164 |
| Conventional | 19 | 38 | 30 | 2.3/2.3 | 373 |
| PVB | | | | 2.1/2.1 | 318 |
| | | | | 2.3/1.6 | 287 |
| | | | | 2.1/1.6 | 242 |
| Stiff PVB-1 | 19 | 30 | 35 | 2.3/2.3 | 539 |
| | | | | 2.1/2.1 | 433 |
| | | | | 2.3/1.6 | 382 |
| | | | | 2.1/1.6 | 360 |
| Stiff PVB-2 | 19 | 20 | 46 | 2.3/2.3 | 1198 |
| | | | | 2.1/2.1 | 988 |
| | | | | 2.3/1.6 | 823 |
| | | | | 2.1/1.6 | 785 |

As can be seen from the results in Table 1, the presently disclosed “Stiff PVB” interlayers have a high contribution to the stiffness of the multiple layer panel when compared to conventional or soft interlayers. In fact, the multiple layer panel with the disclosed stiff or high rigidity interlayers (i.e., “Stiff PVB”) will result in a multiple layer panel with a deflection stiffness at least 20% higher than a multiple layer panel of the same thickness and glass configuration but with a conventional (non-stiff) interlayer.

Table 1 further demonstrates that plasticizer content contributes to the stiffness of the polymer interlayer sheet. As seen in Table 1, polymer interlayer sheets having a plasticizer content of 30 phr or less are associated with higher deflection stiffness levels—the lower the percentage of plasticizer in the polymer interlayer, the stiffer the interlayer. Thus, plasticizer content can be used as a parameter to create and identify stiffer polymer interlayer sheets.

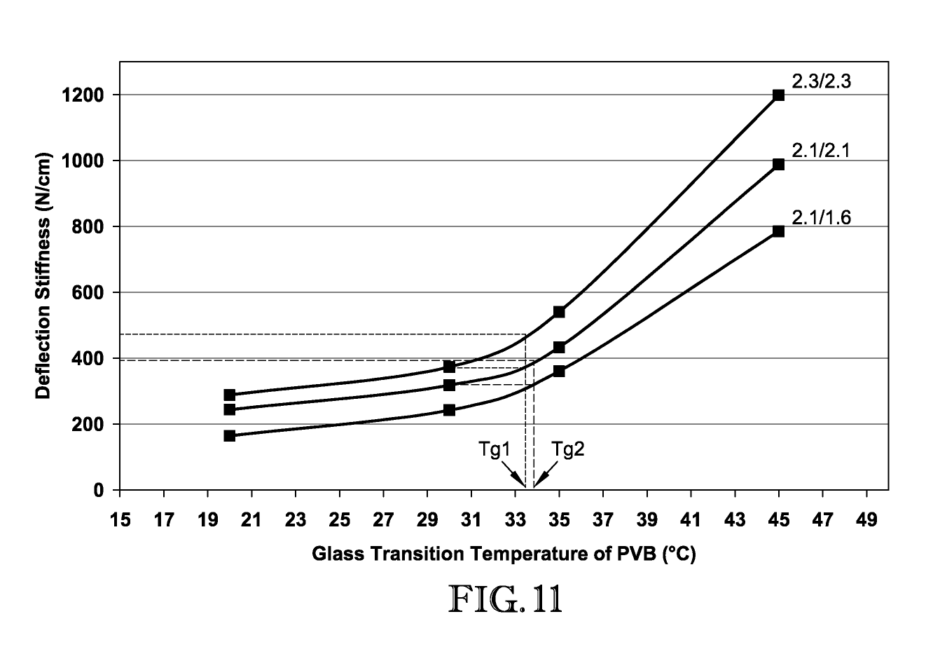

Table 1 also demonstrates that, in addition to plasticizer content, the deflection stiffness of a multiple layer panel is directly correlated with the glass transition temperature of the PVB interlayer in the multiple layer panel—the greater the glass transition temperature of the PVB interlayer, the greater the bending stiffness of the multiple layer panel. This correlation is further shown in FIG. 11, which depicts the deflection stiffness vs. glass transition temperature of the interlayer and glass configurations from Table 1. FIG. 11 also shows that the deflection stiffness is greatly influenced by the nature of the interlayer sandwiched between the substrate panels.

Additionally, FIG. 11 demonstrates that there is an apparent deflection point present in the deflection stiffness vs. glass transition temperature of the interlayer for each of the glass configurations and occurs at about 33° C. Above this temperature, the deflection stiffness of the multiple layer panel increases more rapidly at temperatures of 33° C. or above than at temperatures below 33° C. Thus, a PVB interlayer with a glass transition temperature of about 33° C. or higher results in an interlayer with a high rigidity/stiffness. In comparison, conventional PVB interlayers generally have a glass transition temperature of 30° C.

The influence of the disclosed interlayers on the deflection stiffness can be further demonstrated in FIG. 11. Specifically, FIG. 11 shows that, by using the disclosed high rigidity interlayers, the glass thickness can effectively be reduced while maintaining the same deflection stiffness. This can be demonstrated by the following process as shown in FIG. 11. A horizontal line (long dashed line) is drawn from the point representing the panel having 2.1/2.1 glass thickness configuration and conventional PVB interlayer (i.e., glass transition temperature of 30° C.) until this horizontal line intersects the curve of deflection stiffness vs. glass transition temperature for 2.1/1.6 glass configuration. The corresponding temperature (T_{g2}) is obtained from the intersecting point. This temperature, which is about 33.8° C., corresponds to a stiff PVB interlayer in the panel having 2.1/1.6 glass configuration that is equivalent in deflection stiffness to the panel having 2.1/2.1 glass configuration and with conventional PVB (i.e., 30° C.). In other words, a panel having 2.1/1.6 glass configuration and a PVB interlayer having glass transition temperature of T_{g2} (33.8° C.) will have deflection stiffness equivalent to a panel having 2.1/2.1 glass configuration and a conventional PVB interlayer.

The long dashed line is then drawn up vertically from the intersecting point of the 2.1/1.6 deflection stiffness curve until the vertical line intersects the deflection stiffness curve of 2.1/2.1 glass configuration. The deflection stiffness corresponding to the intersecting point on the 2.1/2.1 glass deflection stiffness curve is determined to be about 390 N/cm. Thus, when in the same glass configuration (i.e., 2.1/2.1), the panel with PVB interlayer having glass transition temperature of 33.8° C. will be about 22.6% stiffer than the panel with a conventional PVB interlayer (deflection stiffness of 318 N/cm).

The above procedures can be applied to a 2.3/2.3 glass panel having a conventional interlayer. As shown in FIG. 11, the 2.3/2.3 glass panel with a conventional interlayer has a deflection stiffness of about 373 N/cm. A horizontal line (short dashed line in FIG. 11) is then drawn to the point where the line intersects the 2.1/2.1 glass panel to determine the glass transition temperature of the disclosed interlayer (i.e., T_{g1}=33.4° C.). As can be seen, the deflection stiffness corresponding to the disclosed interlayer (i.e., glass transition temperature of 33.4° C.) in the 2.3/2.3 panel is about 470 N/cm (short dashed line as shown in FIG. 3). Thus, the disclosed interlayer will contribute to the overall deflection stiffness of the panel by an additional 26% (i.e., 470 N/cm compared to 373 N/cm).

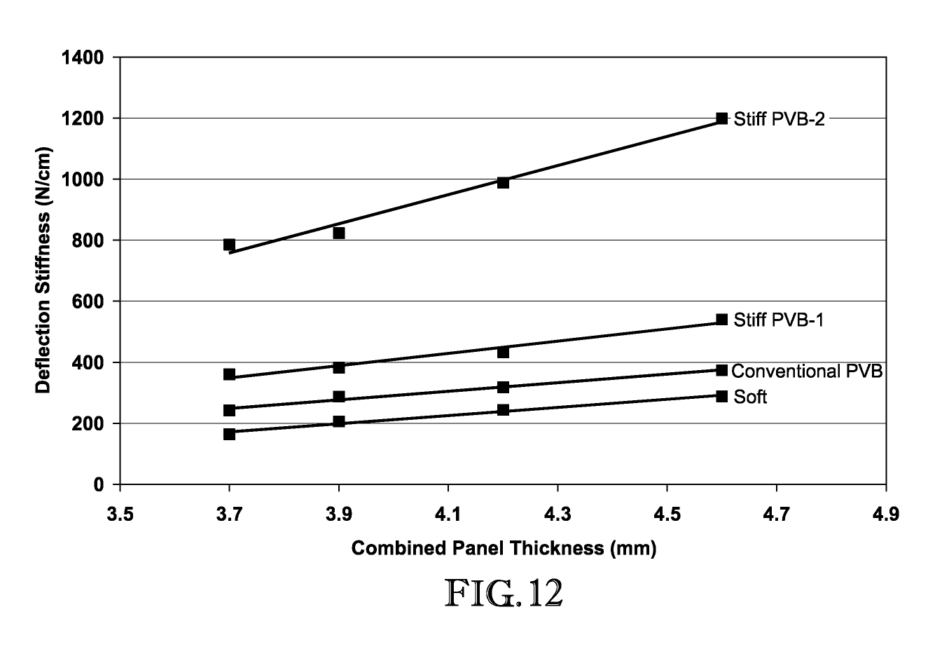

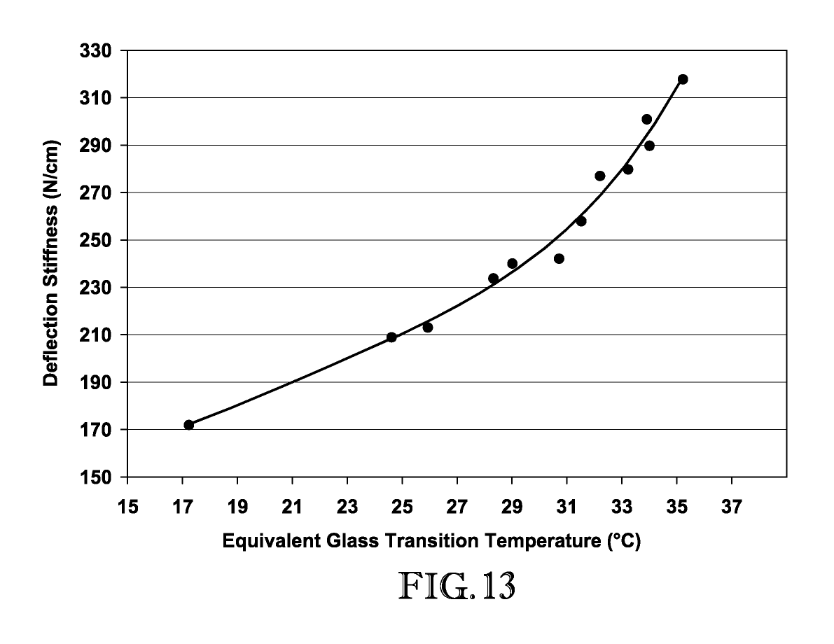

FIG. 12 depicts the deflection stiffness vs. the combined glass thickness of the interlayers from Table 1. This figure further demonstrates the effect the disclosed interlayers have on the deflection stiffness of the multiple layer panel. As clearly shown in FIG. 12, Stiff PVB-1 contributes to the deflection stiffness of the multiple layer panel in such a manner that the deflection stiffness of the light weight glass panels (i.e., total combined glass thickness of 3.7 mm) is essentially equivalent to the heavier multiple layer panel having a combined glass thickness of 4.6 mm and with a conventional PVB interlayer. Thus, the multiple layer panel with Stiff PVB-1 can afford a reduction in glass thickness by as much as 0.9 mm, or 19.6% weight saving in glass, from a multiple layer panel having a conventional PVB interlayer and a combined glass thickness of 4.6 mm while maintaining equivalent stiffness and mechanical rigidity.

### Example 2

In another embodiment of this application, multilayered interlayers having high rigidity layers are also incorporated into a multiple layer panel. For example, in addition to the two substrate panels which have a combined thickness of 4.0 mm or less and the stiff PVB layer (i.e., a PVB layer having a glass transition temperature of at least 33° C.), the light weight multiple layer panel may further comprise a PVB layer that exhibits a glass transition temperature significantly lower than that of conventional PVB (i.e., the second PVB layer). In an embodiment, this second PVB layer will have a glass transition temperature of 15° C. or lower. This additional PVB layer with a low glass transition temperature is included to improve the acoustic attenuation (i.e., sound reduction) of the multiple layer panel.

Table 2 provides numerous examples of the disclosed multilayered interlayer constructions (designated as “Interlayers 1-8”) for various glass configurations (to form multiple layer glass panels of various thicknesses). The “Conventional Acoustic PVB” interlayer refers to the previously utilized conventional acoustic interlayers. All the multilayered interlayers were subjected to the three point bending method to determine deflection stiffness. Table 3 provides the compositions and characteristics of the layers shown in Table 2. FIG. 5 provides a graphical illustration of the relationship of the deflection stiffness and equivalent glass transition temperature (T_{eq}), based on the data provided in Table 2.

TABLE 2

| | | | | Equivalent | | | |
|---|---|---|---|---|---|---|---|
| | Multilayered interlayer | | | Glass | Glass | | Sound |
| | construction | | | Transition | configuration | Deflection | Transmission |
| Interlayer | Layer | Layer | Layer | Temperature | (mm or | Stiffness | Loss (dB) |
| No | 1 | 2 | 3 | (° C.) | mm/mm) | (N/cm) | TL_{ref} |
| Reference | — | — | | — | 4.7 | — | 29 |
| Conventional | PVB-1 | PVB-2 | PVB-1 | 25.9 | 2.3/2.3 | 315 | 39 |
| Acoustic PVB | | | | | 2.1/2.1 | 282 | 39 |
| | | | | | 2.1/1.6 | 213 | 39 |
| Interlayer-1 | PVB-3 | PVB-4 | PVB-3 | 28.3 | 2.3/2.3 | 335 | 34 |
| | | | | | 2.1/2.1 | 299 | 34 |
| | | | | | 2.1/1.6 | 234 | 34 |
| Interlayer-2 | PVB-5 | PVB-2 | PVB-5 | 31.5 | 2.3/2.3 | 350 | 40 |
| | | | | | 2.1/2.1 | 326 | 39 |
| | | | | | 2.1/1.6 | 258 | 39 |
| Interlayer-3 | PVB-6 | PVB-2 | PVB-6 | 33.2 | 2.3/2.3 | 402 | 39 |
| | | | | | 2.1/2.1 | 362 | 39 |
| | | | | | 2.1/1.6 | 280 | 39 |
| Interlayer-4 | PVB-7 | PVB-2 | PVB-7 | 34 | 2.3/2.3 | 403 | 39 |
| | | | | | 2.1/2.1 | 378 | 39 |
| | | | | | 2.1/1.6 | 290 | 39 |
| Interlayer-5 | PVB-7 | PVB-8 | PVB-7 | 35.2 | 2.3/2.3 | 437 | 38 |
| | | | | | 2.1/2.1 | 406 | 38 |
| | | | | | 2.1/1.6 | 318 | 38 |
| Interlayer-6 | PVB-9 | PVB-2 | PVB-9 | 29 | 2.3/2.3 | 341 | 39 |
| | | | | | 2.1/2.1 | 314 | 39 |
| | | | | | 2.1/1.6 | 240 | 39 |
| Interlayer-7 | PVB-10 | PVB-2 | PVB-10 | 30.7 | 2.3/2.3 | 363 | 39 |
| | | | | | 2.1/2.1 | 317 | 39 |
| | | | | | 2.1/1.6 | 242 | 39 |
| Interlayer-8 | PVB-7 | PVB-11 | PVB-7 | 32.2 | 2.3/2.3 | 388 | 39 |
| | | | | | 2.1/2.1 | 345 | 39 |
| | | | | | 2.1/1.6 | 277 | 39 |

TABLE 3

| | | Plasticizer | | |
|---|---|---|---|---|
| | PVOH | (3-GEH) | | Glass |
| | content in | Content | Sheet | transition |
| PVB | PVB | (phr) in | Thickness | temperature |
| layer | (wt %) | PVB | (mil) | (° C.) |
| PVB-1 | 18.7 | 38 | 14 | 30 |
| PVB-2 | 11.8 | 75 | 5 | 3 |
| PVB-3 | 15.4 | 28 | 13 | 32 |
| PVB-4 | 11.8 | 55 | 5 | 9 |
| PVB-5 | 21 | 35 | 13 | 37 |
| PVB-6 | 21 | 30 | 13 | 39 |
| PVB-7 | 21 | 28 | 13 | 40 |
| PVB-8 | 11.8 | 75 | 4 | 3 |
| PVB-9 | 20.4 | 35 | 13 | 34 |
| PVB-10 | 20.8 | 34 | 13 | 36 |
| PVB-11 | 10 | 75 | 5 | −3 |

As Table 2 demonstrates, the high rigidity layers (layers 1 and 3) in multilayered Interlayers 2-8 contribute to the deflection stiffness of the multiple layer panel in such a way that the deflection stiffness of the lighter weight glass configuration (i.e., combined glass thickness of 3.7 mm) is essentially equivalent to the heavier multiple layer panel (i.e., combined glass thickness of 4.2 mm) having a conventional multilayered interlayer (designated as “Conventional Acoustic PVB). Thus, the multiple layer panel comprising the disclosed multilayered interlayers (i.e., Interlayers 2-8—with high rigidity PVB layers (layers 1 and 3) and an acoustic attenuating interlayer (layer 2)) can afford a reduction in glass thickness by as much as 0.5 mm, or 11.9% weight saving in glass, when compared to heavier, previously utilized multiple layer panels with conventional multilayered interlayers. Moreover, the light weight multiple layer panels comprising the multilayered interlayers with high rigidity layers maintain equivalent stiffness, mechanical rigidity, and acoustic properties as the heavier, previously utilized multiple layer panels with conventional acoustic interlayers.

Table 2 also demonstrates the dependence of the deflection stiffness of the multilayered interlayer panel on the equivalent glass transition temperature (T_{eq}). Increasing the equivalent glass transition temperature (T_{eq}) of the interlayer increases its deflection stiffness. It is apparent that the panels having interlayers having the equivalent glass transition temperature (T_{eq}) of at least 28.5° C. and higher have the improved deflection stiffness over the panels having conventional acoustic PVB interlayers.

It should be noted that while Interlayer-1 provides improved deflection stiffness over the conventional acoustic PVB, its acoustic attenuation is significantly lower and not desirable for applications requiring acoustic attenuation. Thus, multilayered interlayers with significantly reduced acoustic attenuation such as Interlayer-1 are generally not preferred.

### Example 3

Several additional polymer layers (PVB-12 to PVB-25) were prepared by mixing and melt blending several poly(vinyl butyral) resins having different residual hydroxyl contents with varying amounts of the plasticizer triethylene glycol bis(2-ethylhexanoate), or 3-GEH. The residual hydroxyl content of the resins and plasticizer content of each polymer layer are summarized in Table 4, below. The glass transition temperature of each polymer layer was determined as described above and the results are provided in Table 4.

TABLE 4

| | | Plasticizer | |
|---|---|---|---|
| | PVOH | (3-GEH) | Glass |
| | content | Content | transition |
| PVB | in PVB | (phr) in | temperature |
| layer | (wt %) | PVB | (° C.) |
| PVB-12 | 18.7 | 38 | 30 |
| PVB-13 | 18.7 | 34 | 32 |
| PVB-14 | 18.7 | 32 | 34 |
| PVB-15 | 21 | 28 | 40 |
| PVB-16 | 15.4 | 28 | 32 |
| PVB-17 | 11.8 | 75 | 3 |
| PVB-18 | 11.8 | 55 | 9 |
| PVB-19 | 10.7 | 75 | −2 |
| PVB-20 | 10.7 | 70 | 1 |
| PVB-21 | 10.7 | 65 | 3 |
| PVB-22 | 10 | 75 | −3 |
| PVB-23 | 9.5 | 75 | −4 |
| PVB-24 | 15.9 | 51 | 17 |
| PVB-25 | 13.5 | 73 | 5 |

Several of the polymer layers listed in Table 4, above, were used to form Comparative Interlayers (CI-1 and CI-2) and Disclosed Interlayers (DI-1 through DI-14), as shown in Table 5, below. Several properties of these interlayers, including equivalent glass transition temperature (T_{eq}), transmission loss at coincident frequency (TL_{c}), and mean break height (MBH), were determined according to the methods described previously, and the results are summarized in Table 5. Although not required, it may be desirable, especially for windshield applications, that the laminate have a mean break height of at least 5.5 m.

TABLE 5

| | | | | | | | | | Equivalent | Transmission | Transmission | |
|---|---|---|---|---|---|---|---|---|---|---|---|---|
| | | | | Thickness (mil) | | | | | Glass | Loss at | Loss at | |
| | | | | | Combined | | Glass transition | | Transition | Reference | Reference | Mean |
| Interlayer | Skin | Core | Skin | Core | Skin | | temperature (° C.) | | Temperature, | Frequency, | Frequency, | Break |
| No. | Layer 1 | Layer | Layer 2 | Layer | Layers | Total | Core | Skin | T_{eq} (° C.) | TL_{ref} (dB) | TL_{ref} (dB) | Height (m [symbol] |
| CI-1 | PVB-12 | PVB-17 | PVB-12 | 5 | 28 | 33 | 3 | 30 | 25.9 | 39 | 37.3 | >5.5 |
| CI-2 | PVB-12 | PVB-19 | PVB-12 | 5 | 28 | 33 | −2 | 30 | 25.2 | 39 | 37.9 | >5.5 |
| DI-1 | PVB-16 | PVB-17 | PVB-16 | 5 | 26 | 31 | 9 | 32 | 28.3 | 34 | 33.7 | >5.5 |
| DI-2 | PVB-16 | PVB-17 | PVB-16 | 10 | 21 | 31 | 9 | 32 | 24.6 | 36 | 35.1 | >5.5 |
| DI-3 | PVB-16 | PVB-17 | PVB-16 | 20 | 11 | 31 | 9 | 32 | 17.2 | 38 | 36.2 | <5.5 |
| DI-4 | PVB-12 | PVB-24 | PVB-17 | 5 | 28 | 33 | 17 | 30 | 26.1 | 33 | 32.6 | >5.5 |
| DI-5 | PVB-12 | PVB-24 | PVB-17 | 10 | 23 | 33 | 17 | 30 | 28.0 | 35 | 34.3 | >5.5 |
| DI-6 | PVB-12 | PVB-25 | PVB-12 | 5 | 28 | 33 | 5 | 30 | 26.2 | 34 | 33.5 | >5.5 |
| DI-7 | PVB-12 | PVB-25 | PVB-12 | 10 | 23 | 33 | 5 | 30 | 22.4 | 39 | 37.0 | >5.5 |
| DI-8 | PVB-13 | PVB-20 | PVB-13 | 5 | 28 | 33 | 1 | 32 | 27.3 | 39 | 38.1 | >5.5 |
| DI-9 | PVB-13 | PVB-20 | PVB-13 | 10 | 23 | 33 | 1 | 32 | 22.6 | 40 | 37.3 | >5.5 |
| DI-10 | PVB-13 | PVB-20 | PVB-13 | 20 | 13 | 33 | 1 | 32 | 13.2 | 40 | 37.0 | <5.5 |
| DI-11 | PVB-14 | PVB-21 | PVB-14 | 4 | 29 | 33 | 3 | 34 | 30.2 | 38 | 36.4 | >5.5 |
| DI-12 | PVB-14 | PVB-21 | PVB-14 | 6 | 27 | 33 | 3 | 34 | 28.4 | 39 | 37.5 | >5.5 |
| DI-13 | PVB-14 | PVB-21 | PVB-14 | 9 | 24 | 33 | 3 | 34 | 25.5 | 40 | 37.0 | >5.5 |
| DI-14 | PVB-15 | PVB-22 | PVB-15 | 5 | 26 | 31 | −3 | 40 | 33.2 | 39 | 37.9 | >5.5 |
| DI-15 | PVB-15 | PVB-22 | PVB-15 | 5 | 30 | 35 | −3 | 40 | 33.9 | 39 | 38.4 | >5.5 |
| DI-16 | PVB-15 | PVB-23 | PVB-15 | 5 | 26 | 31 | −4 | 40 | 32.9 | 39 | 38.5 | >5.5 |

[symbol]

indicates data missing or illegible when filed

Samples of Comparative Interlayer CI-1 and of Disclosed Interlayers DI-1 through DI-3 were then used to construct several multiple layer panels having different glass thicknesses. The configuration of each panel is summarized in Table 6, below. The deflection stiffness of each panel was then determined according to the three-point bending test described previously, and the results are provided in Table 6.

TABLE 6

| | | | Equivalent | | Deflec- |
|---|---|---|---|---|---|
| | | Glass | Glass | Glass | tion |
| | Layer 2 | transition | Transition | config- | stiff- |
| Interlayer | thickness | Temperature | temperature | uration | ness |
| no. | (mil) | Layer 2 | T_{eq} | (mm/mm) | (N/cm) |
| CI-1 | 5 | 3 | 25.9 | 2.3/2.3 | 315 |
| | | | | 2.1/2.1 | 282 |
| | | | | 2.1/1.6 | 213 |
| DI-1 | 5 | 9 | 28.3 | 2.3/2.3 | 335 |
| | | | | 2.1/2.1 | 299 |
| | | | | 2.1/1.6 | 234 |
| DI-2 | 10 | 9 | 24.6 | 2.3/2.3 | 304 |
| | | | | 2.1/2.1 | 284 |
| | | | | 2.1/1.6 | 209 |
| DI-3 | 20 | 9 | 17.2 | 2.3/2.3 | 287 |
| | | | | 2.1/2.1 | 264 |
| | | | | 2.1/1.6 | 172 |

As shown in Tables 5 and 6, above, Comparative Interlayers CI-1 and CI-2 each exhibit a sound transmission loss at the coincident frequency (TL_{c}) of 39 dB and a mean break height greater than 5.5 m, which would be considered acceptable for most windshield applications. However, the low equivalent glass transition temperature (T_{eq}) of these interlayers coupled with the low deflection stiffness of the panels indicates that these interlayers would perform poorly if utilized with thinner glass panels. Several of the Disclosed Interlayers shown in Tables 5 and 6, however, do exhibit both sufficient strength and rigidity, as shown by the equivalent glass transition temperature (T_{eq}) and mean break height (MBH), and suitable acoustic performance, as shown by sound transmission loss at the coincident frequency (TL_{c}), when combined with thinner glass panels to form multiple layer panels. For example, Disclosed Interlayers DI-1, DI-4 through DI-6, DI-8, DI-11 and DI-12, and DI-14 through DI-16 would each have an equivalent glass transition temperature (T_{eq}) greater than 26° C. and a mean break height (MBH) greater than 5.5 m, while also having a sound transmission loss at the coincident frequency (TL_{c}) of greater than 35 dB.

Additionally, also shown in Tables 5 and 6 above, the thickness of the individual polymer layers used to construct the multiple layer interlayers can also impact the performance of the multiple layer panel. For example, the thickness of the inner “core” layer and/or the combined thickness of the outer “skin” layers have an effect on both the sound performance, as well as the overall strength and rigidity, of the interlayer and, ultimately, the multiple layer panel. For example, as shown by a comparison of Disclosed Interlayers DI-1 through DI-3 and DI-8 through DI-10 in Tables 5 and 6, above, an increase in thickness of the core layer from 5 mils (DI-1 and DI-8) to 20 mils (DI-3 and DI-10) results in an overall improvement in acoustic performance, as shown by the increase in sound transmission loss from 34 dB to 38 dB. However, when the increase in core layer thickness is accompanied by an overall reduction in the combined thickness of the skin layers, the resulting panel may exhibit a reduced impact performance, as shown by, for example, the reduced MBH of Disclosed Interlayers DI-3 and DI-10 (<5.5 m), or by a reduced deflection stiffness at a given glass configuration, as shown by comparison of Disclosed Interlayers DI-1 through DI-3 in Table 6.

Additionally, several multiple layer panels, each having different glass configurations, were constructed using interlayer samples of Disclosed Interlayers DI-14 and DI-15, which are shown in Table 5. The deflection stiffness of each of these panels was then determined according to the three-point bending test described previously, and the results are provided in Table 7.

TABLE 7

| | | | Equivalent | | Deflec- |
|---|---|---|---|---|---|
| | | Glass | Glass | Glass | tion |
| | Total | transition | Transition | config- | stiff- |
| Interlayer | thickness | Temperature | temperature | uration | ness |
| no. | (mil) | Layer 2 | T_{eq} | (mm/mm) | (N/cm) |
| DI-14 | 31 | −3 | 33.1 | 2.3/2.3 | 388 |
| | | | | 2.1/2.1 | 345 |
| | | | | 2.1/1.6 | 277 |
| DI-15 | 35 | −3 | 33.9 | 2.3/2.3 | 430 |
| | | | | 2.1/2.1 | 400 |
| | | | | 2.1/1.6 | 301 |

As shown in Tables 5 and 7, above, Disclosed Interlayers DI-14 and DI-15 have the same core layer thickness (5 mils), same core layer glass transition temperature (−3° C.) and same skin layer glass transition temperature (40° C.). However, as shown in Table 7, the total thickness of Disclosed Interlayer DI-14 was 4 mils less than the total thickness of Disclosed Interlayer DI-15, which, as shown by Table 5, resulted from Disclosing Interlayer DI-14 having a combined skin layer thickness 4 mils thinner than the combined skin layer thickness of Disclosed Interlayer DI-15. As a result, the equivalent glass transition temperature (T_{eq}) of DI-15 was 0.8° C. higher. However, upon comparison of the deflection stiffnesses of the two panels, for a specified glass configuration, it was found that the deflection stiffness of the panel formed using Disclosed Interlayer DI-15 was more than 15 percent higher than the deflection stiffness of the panel formed with Disclosed Interlayer DI-14. Thus, the combined thickness of the outer skin layers may have an impact on the deflection stiffness of the panel incorporating the interlayer.

### Example 4

Several poly(vinyl butyral) resins were combined with varying amounts of plasticizer to form polymer layers, which were then used to form additional Comparative Interlayers (CI-3 through CI-5) and Disclosed Interlayers (DI-17 through DI-22), as shown in Table 8a. Each of the disclosed interlayers CI-3 through CI-5 were formulated with a poly(vinyl butyral) resin and the plasticizer 3-GEH, while the Disclosed Interlayers were formulated with either 3-GEH (Plasticizer A) alone or with 3-GEH blended with another plasticizer, nonylphenyl tetraethylene glycol (Plasticizer B). The residual hydroxyl content of each of the poly(vinyl butyral) resins used to formulate the skin and core layers of each of Comparative Interlayers CI-3 through CI-5 and Disclosed Interlayers DI-17 through DI-22, along with the types and amounts of plasticizer used in each layer, are summarized in Table 8a. The glass transition temperatures of each polymer layer, alone and within the interlayer, was measured according to the procedure described previously and the results are also provided in Table 8b.

TABLE 8a

| | Skin Layers | | | Core Layer | | | | | |
|---|---|---|---|---|---|---|---|---|---|
| | Residual | | | Residual | | | | | |
| | Hydroxyl | | | Hydroxyl | | | Skin Layers | Core Layer | Interlayer |
| Interlayer | Content | Plasticizer A | Plasticizer B | Content | Plasticizer A | Plasticizer B | Thickness | Thickness | Plasticizer |
| No. | (wt %) | (phr) | (phr) | (wt %) | (phr) | (phr) | (mils) | (mils) | Content (phr) |
| CI-3 | 18.7 | 38 | 0 | 10.7 | 75 | 0 | 30 | 3 | 41 |
| CI-4 | 18.7 | 38 | 0 | 10.7 | 75 | 0 | 28.5 | 4.5 | 42 |
| CI-5 | 18.7 | 38 | 0 | 10.7 | 75 | 0 | 26 | 7 | 44 |
| DI-17 | 18.7 | 34 | 4 | 10.7 | 66 | 9 | 28.5 | 4.5 | 42 |
| DI-18 | 20.4 | 35 | 0 | 10.7 | 75 | 0 | 28.5 | 4.5 | 39 |
| DI-19 | 20.4 | 31 | 4 | 10.7 | 66 | 9 | 28.5 | 4.5 | 39 |
| DI-20 | 20.4 | 28 | 7 | 10.7 | 60 | 15 | 28.5 | 4.5 | 39 |
| DI-21 | 21 | 32 | 0 | 10.7 | 75 | 0 | 28.5 | 4.5 | 37 |
| DI-22 | 21 | 32 | 0 | 9.5 | 75 | 0 | 29 | 4 | 36 |

TABLE 8b

| | Glass transition | | Glass transition temperature | |
|---|---|---|---|---|
| | temperature of layer (° C.) | | in interlayer (° C.) | |
| Interlayer | Core | Skin | Core | Skin |
| No. | Layer | Layers | Layer | Layers |
| CI-3 | −2 | 30 | 4 | 34 |
| CI-4 | −2 | 30 | 2 | 34 |
| CI-5 | −2 | 30 | 1 | 34 |
| DI-17 | −2 | 32 | 3 | 36 |
| DI-18 | −2 | 34 | 2 | 38 |
| DI-19 | −2 | 37 | 2 | 40 |
| DI-20 | −3 | 36 | 2 | 40 |
| DI-21 | −2 | 38 | 2 | 41 |
| DI-22 | −3 | 38 | 1 | 43 |

Comparative Interlayers CI-3 through CI-5 each have skin and core layers formed of the same poly(vinyl butyral) resin and having the same plasticizer content, but differing in the thickness of the core layer. As shown in Tables 8a and 8b, the thicker core layer of CI-5 (7 mils) results in a higher interlayer plasticizer content (44 phr) and a lower interlayer glass transition temperature for the core layer (1° C.) than for Comparative Interlayers CI-3 and CI-4, which have thinner core layers. This is due to the composite effect, which increases the glass transition temperature of each layer within the interlayer.

As shown in Table 8a, Disclosed Interlayers DI-17 through DI-21 also included core layers formed of the same poly(vinyl butyral) resin and including the same total amount of plasticizer as each other and as Comparative Interlayers CI-3 through CI-5. However, as shown in Table 8b, Disclosed Interlayers DI-17 and DI-21 included skin layers having a higher glass transition temperature than the skin layers employed by Comparative Interlayers CI-3 through CI-5 and include polymer layers having, for example, a poly(vinyl butyral) resin having a higher residual hydroxyl content (DI-18 and DI-21), a blend of plasticizers (DI-17), or both a poly(vinyl butyral) resin having a higher residual hydroxyl content and a blend of plasticizers (DI-19 and DI-20). As a result, the skin layers utilized in Disclosed Interlayers DI-17 through DI-22 had a glass transition temperature that is between 2 and 8° C. higher than the glass transition of the skin layers of Comparative Interlayers CI-3 through CI-5.

Additionally, the shear storage modulus (G′) at each of the ⅓ octave bands in the 2000-8000 Hz frequency range was determined for each of the skin layers used in forming Comparative Interlayers CI-3 through CI-5 and Disclosed Interlayers DI-17 through DI-22, and the results are provided in Table 9, below. As shown in Table 9, the skin layers of Disclosed Interlayers DI-17 through DI-22 have a higher shear storage modulus (G′), at each of the one-third octave bands, than each of Comparative Interlayers CI-3 through CI-5. Additionally, the average shear storage modulus (G′) is at least 10 MPa higher for each of Disclosed Interlayers DI-17 through DI-22 as compared to the Comparative Interlayers.

Next, several glass panels having a 2.3 mm glass/interlayer/2.3 mm glass configuration were prepared as described in Example 2 above using several samples of Comparative Interlayers CI-3 through CI-5 and Disclosed Interlayers DI-17 through DI-22. The sound transmission loss of each of the resulting Comparative Panels, CG-1 through CG-3, and the resulting Disclosed Panels, DG-1 through DG-6, was measured at 20° C. according to ASTM E90 (09). The results, which include the sound transmission loss for each of the ⅓ octave bands in a frequency range of 2000-8000 Hz, the sound transmission loss at the coincident frequency (TL_{c}), and the weighted average sound transmission low (TL_{w}), are provided in Table 10, below.

TABLE 9

| | | | | | | | | | Difference |
|---|---|---|---|---|---|---|---|---|---|
| | | | | | | | | Average | from |
| Interlayer | Shear Storage Modulus G′ (10⁶ MPa) of Skin Layer | | | | | | | G′ | Comparative |
| No. | 2000 | 2500 | 3150 | 4000 | 5000 | 6300 | 8000 | (MPa) | G′ |
| CI-3 | 135.0 | 138.2 | 141.6 | 145.0 | 148.2 | 151.6 | 155.1 | 145.0 | — |
| CI-4 | 135.0 | 138.2 | 141.6 | 145.0 | 148.2 | 151.6 | 155.1 | 145.0 | — |
| CI-5 | 135.0 | 138.2 | 141.6 | 145.0 | 148.2 | 151.6 | 155.1 | 145.0 | — |
| DI-17 | 146.3 | 149.3 | 152.3 | 155.5 | 158.5 | 161.5 | 164.7 | 155.4 | 10.5 |
| DI-18 | 156.6 | 159.3 | 162.0 | 164.9 | 167.6 | 170.4 | 173.2 | 164.9 | 19.9 |
| DI-19 | 156.7 | 159.3 | 162.0 | 165.1 | 167.8 | 170.4 | 173.5 | 165.0 | 20.0 |
| DI-20 | 155.6 | 158.3 | 161.1 | 164.0 | 166.7 | 169.5 | 172.4 | 163.9 | 19.0 |
| DI-21 | 173.9 | 175.9 | 178.1 | 180.3 | 182.4 | 184.5 | 187.2 | 180.3 | 35.4 |
| DI-22 | 173.9 | 175.9 | 178.1 | 180.3 | 182.4 | 184.5 | 187.2 | 180.3 | 35.4 |

TABLE 10

| Glass | Interlayer | 2000-8000 Hz ⅓ Octave Band Sound Transmission Loss (dB) | | | | | | | TL_{w} | TL_{c} |
|---|---|---|---|---|---|---|---|---|---|---|
| Panel | No. | 2000 | 2500 | 3150 | 4000 | 5000 | 6300 | 8000 | (dB) | (dB) |
| CG-1 | CI-3 | 39.3 | 39.5 | 39.7 | 39.0 | 37.8 | 41.3 | 45.4 | 41.0 | 37.8 |
| CG-2 | CI-4 | 39.9 | 39.8 | 39.9 | 39.3 | 37.9 | 40.6 | 45.1 | 41.0 | 37.9 |
| CG-3 | CI-5 | 40.1 | 40.9 | 40.9 | 39.8 | 37.8 | 39.4 | 43.9 | 40.8 | 37.8 |
| DG-1 | DI-17 | 39.6 | 39.8 | 39.9 | 39.3 | 38.9 | 42.6 | 47.0 | 42.1 | 38.9 |
| DG-2 | DI-18 | 40.5 | 40.5 | 40.1 | 40.0 | 38.5 | 41.7 | 46.4 | 41.9 | 38.5 |
| DG-3 | DI-19 | 40.3 | 40.2 | 39.9 | 39.1 | 39.4 | 43.0 | 48.1 | 42.8 | 39.1 |
| DG-4 | DI-20 | 40.1 | 39.8 | 39.9 | 39.2 | 39.2 | 42.5 | 47.8 | 42.5 | 39.2 |
| DG-5 | DI-21 | 39.8 | 40.1 | 40.5 | 39.6 | 39.2 | 42.5 | 47.1 | 42.2 | 39.2 |
| DG-6 | DI-22 | 39.3 | 40.1 | 40.2 | 39.0 | 38.9 | 42.6 | 47.0 | 42.1 | 38.9 |

As shown by Comparative Panels CG-1 through CG-3 in Table 10, above, variation of the thickness of the core layer in a comparative multilayer interlayer has little to no effect on the sound transmission loss through the panel. For example, as shown in Table 10, Comparative Panel CG-1, which had a core thickness of 2 mils, has substantially the same sound transmission loss at the coincident frequency (TL_{c}) and weighted average sound transmission loss (TL_{w}) as Comparative Panels CG-2 and CG-3, which had core layer thicknesses of 4.5 mils and 7 mils, respectively.

However, as shown by Disclosed Panels DG-1 through DG-5 in Table 10, panels formed from interlayers having generally stiffer skin layers resulted in enhanced sound transmission loss, as compared to, for example, Comparative Panel CG-2, which utilizes an interlayer having a core layer of similar thickness as Disclosed Panels DG-1 through DG-5, but with softer skin layers.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. For example, a polymer layer can be formed comprising plasticizer content in any of the ranges given in addition to any of the ranges given for residual hydroxyl content, where appropriate, to form many permutations that are within the scope of the present invention but that would be cumbersome to list.

What is claimed is:

1. A multilayer interlayer comprising:
a first polymer layer comprising a first poly(vinyl butyral) resin and at least two plasticizers, wherein each plasticizer is present in said first polymer layer in an amount of at least 4 parts per hundred resin (phr), and wherein said first polymer layer has a glass transition temperature of at least 35° C. in said interlayer; and
a second polymer layer adjacent to and in contact with said first polymer layer, wherein said second polymer layer comprises a second poly(vinyl butyral) resin and at least one plasticizer, wherein said second polymer layer has a glass transition temperature of less than 20° C. in said interlayer,
wherein said interlayer has an equivalent glass transition temperature of at least 27° C.

2. The interlayer of claim 1, wherein the residual hydroxyl content of said first poly(vinyl butyral) resin is at least 7 weight percent different than the residual hydroxyl content of said second poly(vinyl butyral) resin.

3. The interlayer of claim 1, wherein at least one of said first and said second polymer layers has an average shear storage modulus in ⅓ octave band frequency of 2,000 to 8,000 Hz of at least 150 MPa.

4. The interlayer of claim 1, wherein said second polymer layer has a maximum thickness of not more than 9 mils.

5. The interlayer of claim 1, wherein said interlayer has an equivalent glass transition temperature of at least 28° C.

6. The interlayer of claim 1, wherein said first poly(vinyl butyral) resin has a residual hydroxyl content of at least 19 weight percent and a total plasticizer content of less than 35 phr.

7. The interlayer of claim 1, further comprising a third polymer layer, wherein said second polymer layer is disposed between and in contact with each of said first and said third polymer layers in said interlayer, wherein said third polymer layer comprises a third poly(vinyl butyral) resin and at least one plasticizer and has a glass transition temperature of at least 33° C., wherein the combined thickness of said first and said third polymer layers is at least 20 mils.

8. The interlayer of claim 1, wherein said interlayer comprises at least one tapered zone having a minimum wedge angle of at least 0.10 mrad.

9. A multilayer interlayer comprising:
a first polymer layer comprising a first poly(vinyl butyral) resin and at least one plasticizer, wherein said first polymer layer has a glass transition temperature of at least 35° C. and comprises at least 30 parts per hundred resin (phr) of said plasticizer, wherein said first poly(vinyl butyral) resin has a residual hydroxyl content of greater than 19 weight percent; and
a second polymer layer adjacent to said first polymer layer in said interlayer, wherein said second polymer layer comprises a second poly(vinyl butyral) resin and at least one plasticizer, wherein said second poly(vinyl butyral) resin has a residual hydroxyl content that is at least 9.5 weight percent different than the residual hydroxyl content of said first poly(vinyl butyral) resin,
wherein at least one of said first and said second polymer layers has an average shear storage modulus in ⅓ octave band frequency of 2,000 to 8,000 Hz of at least 150 MPa and/or wherein said interlayer has a weight average sound transmission loss (TL_{w}), measured between 2,000 and 8,000 Hz according to ASTM E-90 (05) at a temperature of 20° C. when laminated between two sheets of glass having dimensions of 80 cm by 50 cm and a thickness of 2.3 mm, of at least 38 dB.

10. The interlayer of claim 9, wherein the plasticizer content of said first polymer layer is not more than 35 phr.

11. The interlayer of claim 9, wherein said first polymer layer has a glass transition temperature that is at least 15° C. higher than the glass transition temperature of said second polymer layer.

12. The interlayer of claim 9, wherein said second polymer layer has a maximum thickness of not more than 9 mils and wherein the glass transition temperature of said second polymer layer is not more than 10° C.

13. The interlayer of claim 9, further comprising a third polymer layer, wherein said second polymer layer is disposed between and in contact with each of said first and said third polymer layers in said interlayer, wherein said third polymer layer comprises a third poly(vinyl butyral) resin and at least one plasticizer, and wherein the third poly(vinyl butyral) resin has a residual hydroxyl content at least 7 weight percent different than the residual hydroxyl content of said second poly(vinyl butyral) resin.

14. The interlayer of claim 9, wherein said first polymer layer has a plasticizer content of not more than about 35 phr, wherein said second polymer layer has a glass transition temperature of not more than 5° C. and a plasticizer content of at least 55 phr, wherein the ratio of the thickness of said first polymer layer to said second polymer layer is at least 1.4:1, and wherein the equivalent glass transition temperature of said interlayer is at least 26° C.

15. The interlayer of claim 9, wherein said interlayer comprises at least one tapered zone having a minimum wedge angle of at least 0.10 mrad.

16. A multiple layer panel comprising:
a pair of rigid substrates; and
an interlayer disposed between said substrates, wherein said interlayer comprises—
a first polymer layer comprising a first poly(vinyl butyral) resin and at least one plasticizer, wherein said first polymer layer has a glass transition temperature of at least 35° C. and wherein said plasticizer is present in said first polymer layer in an amount of less than 30 parts per hundred resin (phr);
a second polymer layer comprising a second poly(vinyl butyral) resin and at least one plasticizer, wherein said plasticizer is present in said second polymer layer in an amount of at least 55 phr; and
a third polymer layer comprising a third poly(vinyl butyral) resin and at least one plasticizer,
wherein said second polymer layer is disposed between and in contact with each of said first and said second poly(vinyl butyral) polymer layers,
wherein said interlayer has an equivalent glass transition temperature of at least 27° C., wherein said interlayer has a sound transmission loss, measured at the coincident frequency according to ASTM E-90 (05) at a temperature of 20° C. when laminated between two sheets of glass having dimensions of 80 cm by 50 cm and a thickness of 2.3 mm, of at least 35 dB and/or a weight average sound transmission loss (TL_{w}), measured between 2,000 and 8,000 Hz according to ASTM E-90 (05) at a temperature of 20° C. when laminated between two sheets of glass having dimensions of 80 cm by 50 cm and a thickness of 2.3 mm, of at least 38 dB,
wherein the combined thickness of said rigid substrates is less than or equal to 4.0 mm.

17. The panel of claim 16, wherein said second polymer layer has a glass transition temperature of less than 9° C. and a thickness of not more than 9 mils.

18. The panel of claim 16, wherein said first polymer layer has a plasticizer content of less than 35 phr and wherein said first poly(vinyl butyral) resin has a residual hydroxyl content of greater than 19 weight percent.

19. The panel of claim 16, wherein said interlayer has an equivalent glass transition temperature of at least 26° C., wherein the combined thickness of said rigid substrates is less than 3.8 mm, and wherein said panel has a deflection stiffness of at least 280 N/cm.

20. The panel of claim 16, wherein the residual hydroxyl content of said first poly(vinyl butyral) resin is at least 7 weight percent different than the residual hydroxyl content of said second poly(vinyl butyral) resin, and wherein the difference between the glass transition temperatures of said first and said second polymer layers is at least 20° C.
